(19) United States
(12) Patent Application Publication
(10) Pub. No.: US 2025/0254531 A1
(43) Pub. Date: Aug. 7, 2025

(54) NETWORK-BASED REPORTING OF TERMINAL AI/ML RELATED INTERNAL ISSUES

(71) Applicant: Sharp Kabushiki Kaisha, Osaka (JP)

(72) Inventors: Rudraksh SHRIVASTAVA, Erligheim (DE); Tomoki YOSHIMURA, Camas, WA (US)

(21) Appl. No.: 18/432,521

(22) Filed: Feb. 5, 2024

(51) Int. Cl. H04W 24/02; H04L 41/16

(52) U.S. Cl. CPC H04W 24/02; H04L 41/16

(57) ABSTRACT

A wireless terminal communicates over a radio interface with a radio network. The wireless terminal comprises processor circuitry and interface circuitry. The processor circuitry is configured to determine an event which pertains to a wireless terminal performance condition which is affected/influenced at least in part by an active Artificial Intelligence/Machine Learning (AI/ML) model or functionality of the wireless terminal and to generate a report message which pertains to the event. The interface circuitry configured is to transmit the report message over the radio interface to the radio network.

### TECHNICAL FIELD

The technology relates to wireless communications, and particularly to telecommunications nodes such as access nodes and mobile stations, e.g., wireless terminals, that utilize artificial intelligence (AI) and/or machine learning (ML).

### BACKGROUND

A radio access network typically resides between wireless devices, such as user equipment (UEs), mobile phones, mobile stations, or any other device having wireless termination, and a core network. Example of radio access network types includes the GERAN, GSM radio access network; the GERAN, which includes EDGE packet radio services; UTRAN, the UMTS radio access network; E-UTRAN, which includes Long-Term Evolution; and g-UTRAN, the New Radio (NR).

A radio access network may comprise one or more access nodes, such as base station nodes, which facilitate wireless communication or otherwise provides an interface between a wireless terminal and a telecommunications system. A non-limiting example of an access node or base station may include, depending on radio access technology type, a Node B (“NB”), an enhanced Node B (“eNB”), a home eNB (“HeNB”), a gNB (for a New Radio [“NR”] technology system), or some other similar terminology.

The 3rd Generation Partnership Project (“3GPP”) is a group that, e.g., develops collaboration agreements such as 3GPP standards that aim to define globally applicable technical specifications and technical reports for wireless communication systems. Various 3GPP documents may describe certain aspects of radio access networks. Overall architecture for a fifth generation system, e.g., the 5G System, also called “NR” or “New Radio”, as well as “NG” or “Next Generation”, is shown in FIG. 1, and is also described in 3GPP TS 38.300. The 5G NR network is comprised of NG-RAN, Next Generation Radio Access Network, and 5GC, 5G Core Network. As shown, NG-RAN is comprised of gNBs, e.g., 5G Base stations, and ng-eNBs, i.e., LTE base stations. An Xn interface exists between gNB-gNB, between (gNB)-(ng-eNB) and between (ng-eNB)-(ng-eNB). The Xn is the network interface between NG-RAN nodes. Xn-U stands for Xn User Plane interface and Xn-C stands for Xn Control Plane interface. A NG interface exists between 5GC and the base stations, i.e., gNB & ng-eNB. A gNB node provides NR user plane and control plane protocol terminations towards the UE, and is connected via the NG interface to the 5GC. The 5G NR, New Radio, gNB is connected to AMF, Access and Mobility Management Function, and UPF, User Plane Function, in the 5GC, 5G Core Network.

In general, “artificial intelligence” (AI) refers to processes and algorithms that are able to simulate human intelligence, including mimicking cognitive functions such as perception, learning and problem solving or refers to a data driven algorithm that applies to techniques to generate a set of outputs based on a set of inputs. Artificial intelligence includes the concept of artificial intelligence (AI) models, which pertain to, e.g., the creation, training, and deployment of machine learning algorithms that emulate logical decision-making based on available data. An AI “model” may be an algorithm which can be trained online (e.g., the AI model may be trained in real time/live conditions using real time data) or offline (e.g., the AI model may have been trained before being deployed) and/or which, e.g., emulates logical decision making or prediction making based on available data with minimal or no human intervention. A “model” may also be considered as a data driven algorithm that applies AI/ML techniques to generate a set of outputs based on a set of inputs. Machine learning (ML) is a subset of AI. ML may include applications of AI that allow machines to extract knowledge from data and learn from it autonomously. As summarized below, use of artificial intelligence (AI) and/or machine learning (ML) have been envisioned to a limited degree for telecommunications.

Artificial Intelligence/Machine Learning (AI/ML) as applied to Life Cycle Management (LCM) procedures for wireless communications is discussed, for example, in RAN1 #111. Additionally, RAN1 #112-bis-e discusses functionality and model identification.

Two approaches for AI/ML Life Cycle Management (LCM) have been identified so far in the 3GPP RAN-1/2 discussions, namely Model-ID based LCM and the Functionality-based LCM.

In Model-ID based LCM, the AI/ML functionality and the associated model are identified by an explicit model ID. In this case, the model ID is mapped to an AI/ML model or algorithm. Thus, the UE may report its artificial intelligence (AI)/machine learning (ML) capability by including the model identifier(s), e.g., model ID(s), for the supported models to the gNB. With this information, the gNB may provide the corresponding LCM assistance utilizing model ID. For transferring the model, the model ID may be used for model identification which may help in selecting a target model for downloading or uploading. For example, model ID may be used for switching, (de) activating or monitoring performance of AI models.

In Functionality-based LCM, by contrast, the functionality is used to point to a model. In other words, functionality is mapped to the model and model is identified via the associated functionality. For example, the supported functionalities, e.g., use case, configuration, scenario, for a certain use case, e.g., e.g., channel estimation, positioning or beamforming, can be specified. Then, the UE may report its capability in relation to the specified functionality. Thus, the network can assign a model ID corresponding to the supported functionality in an implicit manner. This approach is comparable to legacy approach for capability report and corresponding RRC configurations.

Considering, e.g., the foregoing, for AI/ML model-ID based LCM purpose, the UE may report its AI/ML capability to the network for model (de) activation, switching, fallback procedure. A UE may have the capability to support AI/ML operations and model-ID based LCM which may be fixed, but its ability at different times to support AI/ML model or associated functionality and meet related performance key performance indicators, KPIs, may be different depending on device performance key performance indicators, KPIs, such as live run-time capabilities, environment, device type, use-case, scenario, device computation usage, power-consumption, antenna configuration etc. The AI/ML model must adapt to the dynamic run-time capabilities of the UE such as RF and Power/resource consumption status etc. Also, the UE may need to optimize its hardware and software resources to support various models and their functions associated to intended use-cases. Such optimizations are critical to consistently meet model and device performance KPIs.

A UE or a device may need to support one or more AI/ML based models/functionality and match the expected model performance KPIs. But at certain times due to the limitations of the device hardware/software resources and/or network side limitations (e.g., signaling delay, resource allocation, model transfer etc.), it may not be able to always support a specific AI/ML model(s) or functionality. Also, the gNB may not configure the UE with more AI/ML models or functionalities beyond UE's capabilities to support it at a given time. Thus, at a given time, gNB may not be aware of real time UE capabilities to support a model or functionality, associated with a target use case. These and other issues, including reporting to the network the wireless terminal's status or live run-time capabilities to be able to support AI/ML models and related functionalities at a given time, are addressed at least in part in U.S. patent application Ser. No. 18/296,799 to SHRIVASTAVA, filed Apr. 6, 2023, entitled “Network Configured Operation of User Equipment With Artificial Intelligence/Machine Learning Model Capability”, which is incorporated herein by reference in its entirety.

There are on-going discussions in RAN1/2 that knowing UE conditions at the network is necessary for functionality identification and functionality-based Life Cycle Management (LCM). Such UE conditions may include, for example, scenarios in which the UE may operate, sites where the UE may be located, the UE configuration, UE data sets and UE parameters including both AI/ML-model and UE configuration parameters, and/or the UE battery status. Knowing the UE conditions is required to reveal the background (UE) conditions when using ML models for supporting a given ML-enabled feature(s). In certain problematic scenarios, the network may tell the UE to fallback to the legacy procedure without ML-enabled feature(s). As used herein “fallback to legacy procedure” may refer to falling back to non-AI/ML 3GPP procedures or mechanisms.

In on-going RAN1/2 discussion the current understanding is that the network can activate/deactivate/switch/fallback/update among the applicable functionalities. The LCM steps of activate/deactivate/switch/fallback/update are made by changing the configuration of the UE. Thus, the activate/deactivate/switch/fallback/update, etc., of AI/ML functionalities would be handled via UE (re) configuration. Thus, if a functionality is switched or de-activated by UE re-configuration considering the set of supported/applicable conditions at a given time, this may implicitly instigate or trigger UE to activate/deactivate/switch/fallback/update the underlying AI/ML model supporting/part of the corresponding functionality.

Acts such as instigating or triggering a UE to activate/deactivate/switch/fallback/update the underlying AI/ML model supporting/part of the corresponding functionality may be problematic. For example, considering UE-side or UE-side of the two-sided model, since the UE has limited storage capacity, the UE may not have all the AI/ML models associated to a functionality supported by the UE. It is also possible that the models that are stored at the UE side may not be fully up to date. The UE(s) may support a feature or functionality but may not update or download all the specialized models for the supported functionality. Therefore, for the AI/ML model-ID based LCM, in some cases it may be problematic to switch functionalities.

In some such cases there may be delays in inferencing and model monitoring which may also lead to performance loss if the existing functionality in use is not able to perform up to the target KPIs. U.S. patent application Ser. No. 18/448,040 to SHRIVASTAVA et al., filed Aug. 10, 2023, entitled “Method and Apparatus for Handling Artificial Intelligence/Machine Learning Functionality or Feature (Re) configuration in a Telecommunications Network”, and U.S. patent application Ser. No. 18/448,064 to SHRIVASTAVA et al., filed Aug. 10, 2023, entitled “Method and Apparatus for Handling Artificial Intelligence/Machine Learning Functionality or Feature (Re) configuration in a Telecommunications Network”, both of which are incorporated herein by reference in its entirety, discloses, e.g., methods, apparatus, and/or techniques which address such issues including avoidance of latency and delays in AI/ML model inference and monitoring and avoidance of any model/UE performance degradation or interruptions in AI enabled feature operation.

Computer chip overheating may result from the intensive computations required for machine learning and artificial intelligence. As an example, deep neural networks require that many computations be done in parallel during the training phase. When there is an excessive amount of heat generated by this high computing load, the hardware may overheat if it is not appropriately managed. In wireless systems, training and applying AI/ML models and functionalities within an AI/ML enabled feature group may cause internal UE overheating (e.g., excess heat) and other UE internal issues. Such other UE internal issues may include limited availability of computational issues, increased AI/ML model complexity and computational complexity for pre- and post, increased training, and inference latency, etc.

Overheating and UE internal issues maybe caused for, e.g., using inappropriate or unoptimized model(s), the model(s) may become obsolete due to changing additional conditions or conditions/scenario around UE. The network configuration of a functionality may not be suitable if the additional conditions or UE scenario or UE environment changes.

What is needed are, e.g., methods, apparatus, and/or techniques which enable wireless communication units to address such issues, e.g., overheating and UE internal issues caused by inappropriate or unoptimized AI.ML models, including methods, apparatus, and/or techniques which enable the UE and network may coordinate with each other to avoid or overcome such issues.

### SUMMARY

In one of its example aspects the technology disclosed herein concerns a wireless terminal which communicates over a radio interface with a radio network. In a basic example embodiment and mode the wireless terminal comprises processor circuitry and interface circuitry. The processor circuitry is configured to determine an event which pertains to a wireless terminal performance condition which is affected/influenced at least in part by an active Artificial Intelligence/Machine Learning (AI/ML) model or functionality of the wireless terminal and to generate a report message which pertains to the event. The interface circuitry configured is to transmit the report message over the radio interface to the radio network. Methods of operating such wireless terminals are also provided.

In another of its example aspects the technology disclosed herein concerns a network including one or more nodes which communicate over a radio interface with a wireless terminal. In a basic example embodiment and mode the network node comprises processor circuitry and interface circuitry. The interface circuitry is configured to receive a report message over the radio interface, the report message comprising information pertaining to a wireless terminal performance condition which is affected/influenced at least in part by an active Artificial Intelligence/Machine Learning (AI/ML) model or functionality of the wireless terminal. The processor circuitry is configured to generate a response message comprising an instruction for the wireless terminal to perform a remedial action. The interface circuitry is further configured to transmit the response message to the wireless terminal over the radio access network. Methods of operating such networks and nodes are also provided.

In one of its example aspects the technology disclosed herein concerns a wireless terminal which communicates over a radio interface with a radio network. In a basic example embodiment and mode the wireless terminal comprises processor circuitry and interface circuitry. The processor circuitry is configured to determine an event which pertains to a wireless terminal performance condition which is affected/influenced at least in part by an active Artificial Intelligence/Machine Learning (AI/ML) model or functionality and to implement a terminal-proposed remedial action configured to implement the wireless terminal performance condition. The processor circuitry is also optionally configured to generate a resolution report message which reports that implementation of the remedial action has resolved the wireless terminal performance condition. The interface circuitry is configured to optionally transmit the report message over the radio interface to the radio network. Methods of operating such wireless terminals are also provided.

In another of its example aspects the technology disclosed herein concerns a network including one or more nodes which communicate over a radio interface with a wireless terminal. In a basic example embodiment and mode the network node comprises processor circuitry and interface circuitry. The interface circuitry is configured to receive a problem report message over the radio interface from the wireless terminal. In an example implementation the problem report message comprises information indicating that a wireless terminal performance condition has not been resolved within a predetermined time by the implementation of a terminal-proposed remedial action. The processor circuitry is configured to generate a response message comprising an instruction for the wireless terminal to perform a network-proposed remedial action. The interface circuitry is further configured to transmit the response message to the wireless terminal over the radio access network. Methods of operating such networks and nodes are also provided.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of overall architecture for a 5G New Radio system.

FIG. 2 is a schematic view of a generic example embodiment and mode of a communications system in which a wireless terminal has artificial intelligence/machine learning model capability and in which the wireless terminal determines its internal issues or overheating due to AI/ML model or functionality.

FIG. 3A is a schematic view of an example embodiment and mode of a communications system in which a wireless terminal has artificial intelligence/machine learning model capability and in which the wireless terminal reports its internal issues or overheating due to AI/ML model or functionality to a network node.

FIG. 3B is a diagrammatic view which shows example, non-limiting, acts or steps including message flow implemented in an example implementation of the example embodiment and mode of FIG. 3A.

FIG. 4A is a schematic view of an example embodiment and mode of a communications system in which a wireless terminal has artificial intelligence/machine learning model capability and in which the wireless terminal attempts to resolve its internal issues or overheating due to AI/ML model or functionality before optionally reporting to a network node.

FIG. 4B is a diagrammatic view which shows example, non-limiting, acts or steps including message flow implemented in an example implementation of the example embodiment and mode of FIG. 4A.

FIG. 5A is a schematic view showing an example of how the example embodiment and mode of FIG. 3A or the example embodiment and mode of FIG. 3B may be implemented in a scenario in which the network node is a core network node.

FIG. 5B is a schematic view showing an example of how the example embodiment and mode of FIG. 3A or the example embodiment and mode of FIG. 3B may be implemented in a scenario in which the network node is a radio access network node.

FIG. 5C is a schematic view showing an example of how the example embodiment and mode of FIG. 3A or the example embodiment and mode of FIG. 3B may be implemented in a scenario in which the network node is distributed between a core network and a radio access network.

FIG. 6 is a diagrammatic view showing example elements comprising electronic machinery which may comprise a wireless terminal, a radio access node, and a core network node according to an example embodiment and mode, and thus how the technology disclosed herein may be implemented, at least in part, by a non-transitory computer readable medium encoded with a computer program that, when executed by a computer or processor of one or more of the terminals and/or nodes described herein, causes the computer to implement the acts described herein.

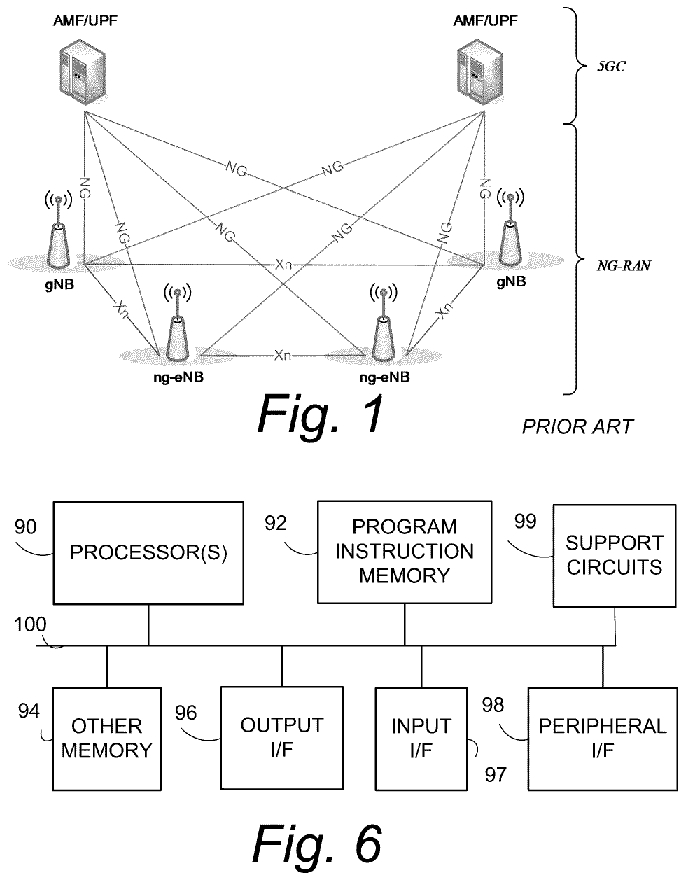

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether such computer or processor is explicitly shown.

As used herein, the term “telecommunication system” or “communications system” can refer to any network of devices used to transmit information. A non-limiting example of a telecommunication system is a cellular network or other wireless communication system. As used herein, the term “cellular network” or “cellular radio access network” can refer to a network distributed over cells, each cell served by at least one fixed-location transceiver, such as a base station. A “cell” may be any communication channel. All or a subset of the cell may be adopted by 3GPP as licensed bands, e.g., frequency band, to be used for communication between a base station, such as a Node B, and a UE terminal. A cellular network using frequency bands can include configured cells. Configured cells can include cells of which a UE terminal is aware and in which it is allowed by a base station to transmit or receive information. Examples of cellular radio access networks include E-UTRAN or New Radio, NR, and any successors thereof, e.g., NUTRAN.

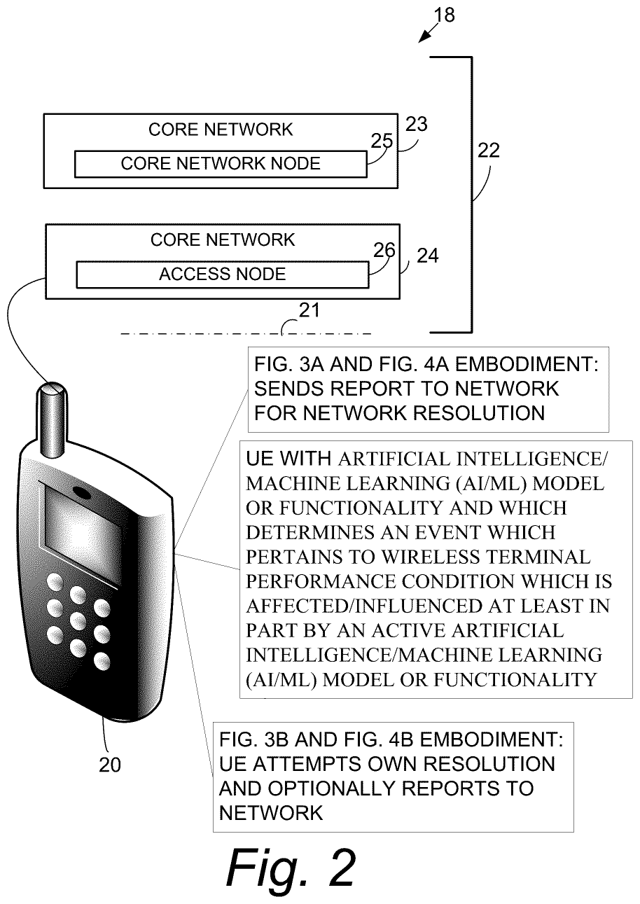

FIG. 2 diagrammatically illustrates in a simplified, generic manner a communications system 18 in which a wireless terminal 20 communicates over a radio or air interface 21 with a communication network 22 which serves the wireless terminal 20. The wireless terminal 20, which may also be referred to as “user equipment” 30 or “UE” 30, includes Artificial Intelligence/Machine Learning (AI/ML) model(s) or functionality(ies), e.g., one or more instances or application of Artificial Intelligence/Machine Learning (AI/ML). In other words, one or more of the functions or operations performed by the wireless terminal 20 may involve or invoke Artificial Intelligence/Machine Learning (AI/ML). As an aspect of the technology disclosed herein, the wireless terminal 20 determines an event which pertains to a wireless terminal performance condition which is affected or influenced, at least in part, by usage or operation of the Artificial Intelligence/Machine Learning (AI/ML) of the wireless terminal 20.

A wireless terminal performance condition or may include one or more of the following:
A UE internal issue, such as irregularities in one or more of device computation resource usage, power-consumption, RF and Power/resource consumption status, memory, battery status, storage, and other hardware limitations, etc.
Overheating due to AI/ML model or functionality configuration or operation, etc.
UE internal conditions and UE additional conditions which may comprise one or more of the following:
   Occurrence of certain scenarios, e.g., a certain channel model, a certain UE distribution, certain UE mobility levels, utilization of certain carrier frequencies, etc.
   Certain configurations, e.g., certain UE/gNB config, utilization of certain bandwidths, certain antenna port layouts.
      Utilization of Certain sites (e.g., Urban Macro, Indoor hotspot, Rural Macro, Urban Micro, cell sites).
      UE's internal conditions such as device computation usage, power-consumption, RF and Power/resource consumption status, memory, battery status, storage, and other hardware limitations etc.
         The foregoing comprises a non-exhaustive list of wireless terminal performance conditions or “internal issues” as utilized herein.

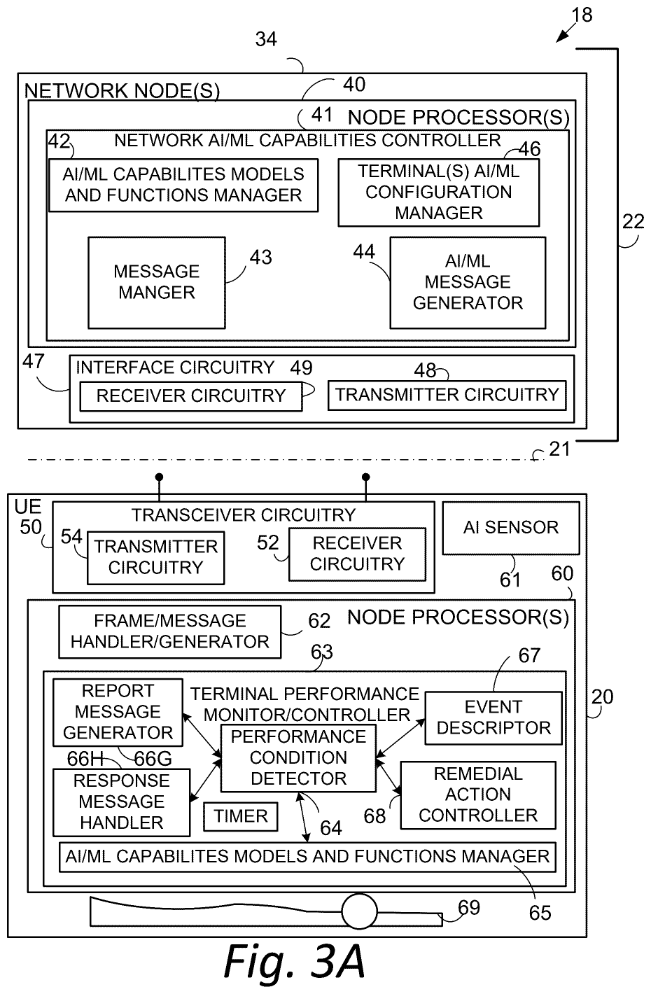

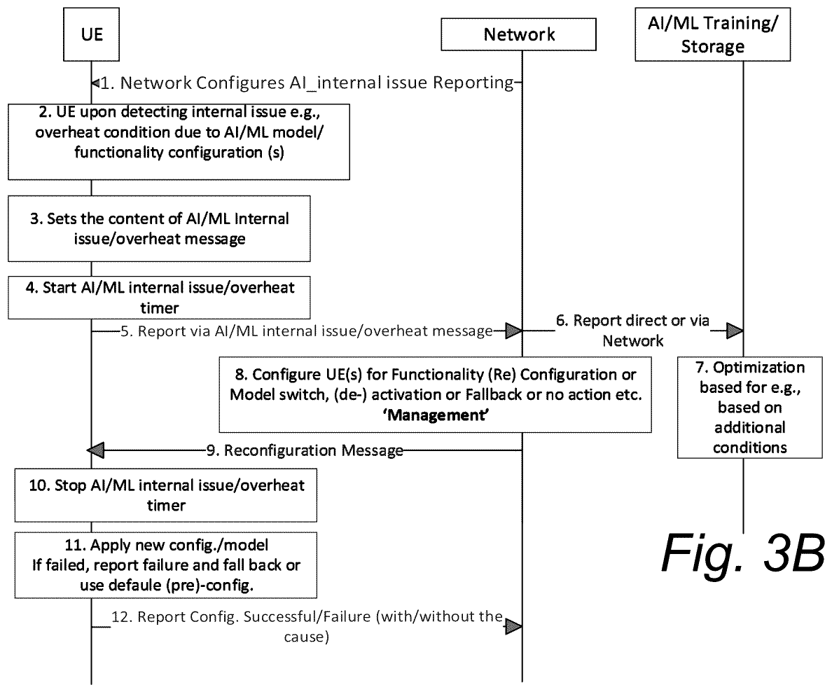

FIG. 2 further indicates that the technology disclosed herein may be implemented in differing embodiments and modes. For example, in a first example embodiment and mode, which is essentially illustrated by and discussed herein with reference to FIG. 3A and FIG. 3B, wireless terminal 20 may generate and send a report to the communications network 22 a message or report, herein also referred to as “report message”, which pertains to the event. In some example embodiments and modes, the report message may essentially indicate occurrence of the event; in other non-limiting example embodiments and modes the report or message may be sent preferably to obtain a network-proposed resolution or network-proposed remediation, e.g., a network-proposed or network-determined or network-prescribed, remedial action, of a wireless terminal performance condition.

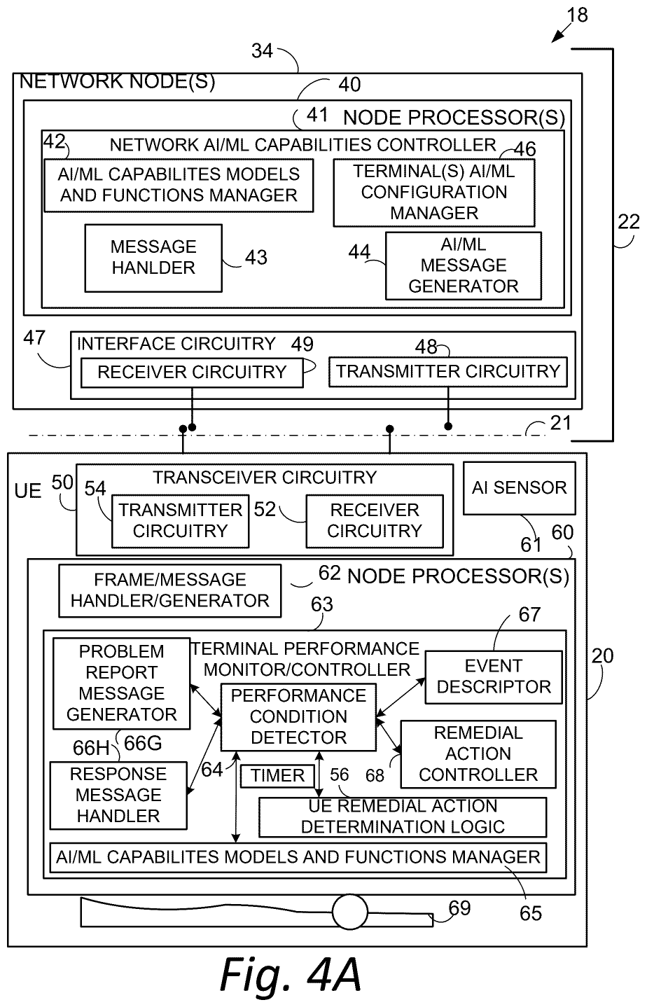

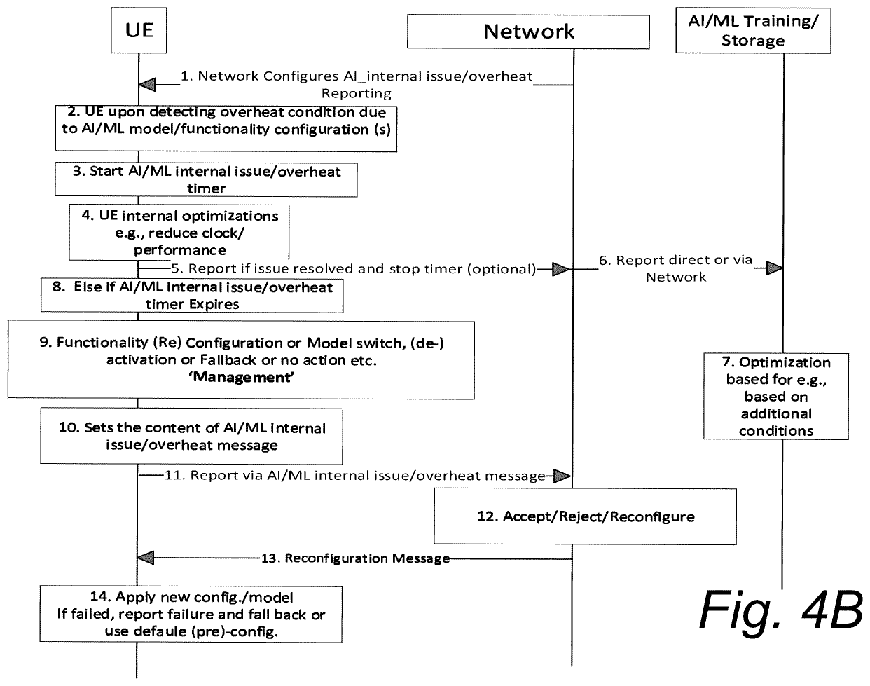

FIG. 2 also illustrates that, in a second example embodiment and mode, which is essentially illustrated by and discussed herein with reference to FIG. 4A and FIG. 4B, wireless terminal 20 may attempt the wireless terminal's own resolution or remediation and may optionally report to the network either the attempted resolution, whether successful or not. As used herein, the wireless terminal's own resolution or remediation may also be referred to as the terminal-proposed or terminal-determined remediation or remedial action.

As used herein, “pertains to a wireless terminal performance condition” includes and/or encompasses any aspect of the wireless terminal, which is affected or influenced by Artificial Intelligence/Machine Learning (AI/ML), reaching, acquiring, or transitioning to a particular or predetermined state, level, or degree of operation, as understood, for example, with reference to the list provided above. As used herein, “affected or influenced, at least in part, by usage or operation of the Artificial Intelligence/Machine Learning (AI/ML)” comprises or encompasses any situation in which Artificial Intelligence/Machine Learning (AI/ML) of the wireless terminal, e.g., any Artificial Intelligence/Machine Learning (AI/ML) model or functionality of the wireless terminal, plays a measurable causation role in the performance of the wireless terminal performance, and particularly actual or potential degradation of performance of the wireless terminal. As used herein, “AI/LM model performance may pertain to, e.g., model accuracy; a device performance key performance indicator, KPI, may comprise or depend upon such issues as throughput and latency, for example.

A first, non-limiting example of a wireless terminal performance condition comprises overheating at the wireless terminal caused, at least in part, by usage of or performance of the Artificial Intelligence/Machine Learning (AI/ML) capabilities. “Overheating” comprises a determination that temperature at the wireless terminal 20 has reached a predetermined temperature level. Overheating detection can be up to UE implementation. Overheating can be detected based on model monitoring or measuring how much resources, e.g., flops, a specific model is using, computation complexity of the model performance monitoring, rate of battery usage, power usage monitoring, if the UE implemented AI/ML models on the dedicated hardware or the common hardware (e.g., GPU, CPU or modem or FPGA or any others) on device sensors

If the AI/ML model is implemented in a dedicated or same hardware then the existing message can be jointly configured and reported in a coordinated and co-related manner, e.g., any changes in the UE modem configuration/parameters/problems may have an impact on the AI/ML model and functionality and vice-versa. Therefore, wireless terminal may check both and set parameters accordingly before communicating it to the network.

Examples of events that pertain to a wireless terminal performance condition which is affected or influenced, at least in party, by usage or operation of the Artificial Intelligence/Machine Learning (AI/ML) of the wireless terminal 20 include (1) an event which pertains to remediation of a wireless terminal performance condition; (2) an event which pertains to checking of the wireless terminal performance condition; and (3) an event which pertains to prediction of the wireless terminal performance condition such as, for example, an event which causes or results in prediction of that remediation of a wireless terminal performance condition should be considered or undertaken.

Examples of events which pertain to remediation of a wireless terminal performance condition may include, as non-limiting examples: (1) an occurrence or onset of the wireless terminal performance condition; and (2) non-occurrence or cessation of the wireless terminal performance condition.

Examples of events which pertain to checking of the wireless terminal performance condition may include, as non-limiting example, a predetermined reporting time and/or the wireless terminal performance condition reaching a report triggering threshold.

As used herein, “pertain to”, e.g., pertain to remediation, pertain to checking, pertains to prediction, may include either requiring or inviting/suggesting/prompting consideration of requiring that a certain action, e.g., remediation, checking, prediction, be undertaken.

The technology disclosed herein concerns, e.g., UE behavior and reporting mechanism(s) when a UE detects UE internal issues due, at least in part, to active AI/ML model or functionality in a feature for a given use case.

Network 22 may also configure triggering conditions to the UE for reporting internal issues or overheating. Such reporting could be event-based or periodic.

The technology disclosed herein also concerns network behavior upon receiving such notification from the UE. For example, the network or the UE may decide to (de) activate, switch, fall back to legacy non-AI/ML procedures etc. or network or UE may request model re-optimization/update.

In certain example, non-limiting embodiments and modes, the technology disclosed herein also comprises a new message like a UAI (user assistance information) message which the UE may use to report its internal issues or overheating due to AI/ML model or functionality to the network.

In certain example, non-limiting embodiments and modes, the UE of the technology disclosed herein may also report to the network when it is not experiencing, or it has stopped experiencing internal issues. For this purpose, an enhanced existing UAI may also be used. For example, the existing UAI for reporting overheating may be enhanced to report internal issues or overheating due to active AI/ML model/functionality.

In certain example, non-limiting embodiments and modes, a modification of existing overheating UAI may be done jointly/together with the new or enhanced AI/ML overheat/internal issue reporting message, a UAI-like message, for a target use-case or an AI/ML feature.

In certain example, non-limiting embodiments and modes, a timer-based approach is proposed to trigger reporting of UE internal issues to the network. In such example embodiments and modes, UE behavior may be defined on timer initiation, stopping and expiry.

In the example embodiments and modes generically depicted in FIG. 2 and more specifically illustrated in FIG. 3A and FIG. 4A, communication network 22 typically comprises at least one core network 23 and one radio access network 24. The core network 23 may comprise one or more core network nodes or servers, such as core network node 25 shown in FIG. 2. A core network, CN, such as core network (CN) 23 may comprise numerous servers, routers, and other equipment. As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc. For example, core network (CN) 23 may comprise one or more management entities, which may be an Access and Mobility Management Function, AMF.

Also as understood, e.g., with reference to FIG. 2, the communication network 22 typically comprises at least one radio access network 24. The radio access network 24 typically comprises one or more access nodes, such as access node 26 shown in FIG. 2. The radio access network 24, and hence its access nodes, are connected to the core network 23 by core network/radio access interface link(s) 27. The core network/radio access interface link(s) 27 may be, for example, a RAN-CN interface (e.g., N2 interface).

As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB (for a New Radio [“NR”] technology system), or some other similar terminology. The access node 26 may include, for example, one or more types of relay nodes.

As mentioned above, communication system 18 of FIG. 2 further comprises wireless terminal 20, which may also be a node of the communications system, and which also may be referred to as user equipment or UE 20. The wireless terminal 20, for which pertinent aspects are described in further detail below, communicates over a radio or wireless interface 21 with the radio access network 24. Depending on system and circumstances of operation, the wireless terminal 20 may wirelessly communicate with one or more access nodes 26 of one or more radio access networks 24. As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc.

Communication between radio access network (RAN) 24 and wireless terminal over the radio interface occurs by utilization of “resources”. Any reference to a “resource” herein means “radio resource” unless otherwise clear from the context that another meaning is intended. In general, as used herein a radio resource (“resource”) is a time-frequency unit that can carry information across a radio interface, e.g., either signal information or data information.

An example of a radio resource occurs in the context of a “frame” of information that is typically formatted and prepared, e.g., by a node. In Long Term Evolution (LTE) a frame, which may have both downlink portion(s) and uplink portion(s), is communicated between the base station and the wireless terminal. Each LTE frame may comprise plural subframes. For example, in the time domain, a 10 ms frame consists of ten one millisecond subframes. An LTE subframe is divided into two slots (so that there are thus 20 slots in a frame). The transmitted signal in each slot is described by a resource grid comprised of resource elements (RE). Each column of the two dimensional grid represents a symbol (e.g., an OFDM symbol on downlink (DL) from node to wireless terminal; an SC-FDMA symbol in an uplink (UL) frame from wireless terminal to node). Each row of the grid represents a subcarrier. A resource element, RE, is the smallest time-frequency unit for downlink transmission in the subframe. That is, one symbol on one sub-carrier in the sub-frame comprises a resource element (RE) which is uniquely defined by an index pair (k, l) in a slot (where k and I are the indices in the frequency and time domain, respectively). In other words, one symbol on one sub-carrier is a resource element (RE). Each symbol comprises a number of sub-carriers in the frequency domain, depending on the channel bandwidth and configuration. The smallest time-frequency resource supported by the standard today is a set of plural subcarriers and plural symbols (e.g., plural resource elements (RE)) and is called a resource block (RB). A resource block may comprise, for example, 84 resource elements, i.e., 12 subcarriers and 7 symbols, in the case of normal cyclic prefix.

In 5G New Radio (“NR”), a frame consists of 10 ms duration. A frame consists of 10 subframes with each having 1 ms duration like LTE. Each subframe consists of 24 slots. Each slot can have either 14 (normal CP) or 12 (extended CP) OFDM symbols. A Slot is a typical unit for transmission used by scheduling mechanism. NR allows transmission to start at any OFDM symbol and to last only as many symbols as required for communication. This is known as “mini-slot” transmission. This facilitates very low latency for critical data communication as well as minimizes interference to other RF links. Mini-slot helps to achieve lower latency in 5G NR architecture. Unlike slots, mini-slots are not tied to the frame structure. It helps in puncturing the existing frame without waiting to be scheduled. See, for example, https://www.rfwireless-world.com/5G/5G-NR-Mini-Slot.html, which is incorporated herein by reference.

As mentioned above, the foregoing are only two examples of types of radio frames suitable for the technology disclosed herein. The technology disclosed herein may also be used with other radio frame structures in 5G-Nr or beyond 5G, e.g., in future communication systems.

### First Example Embodiment: Network-Initiated Cases

The technology disclosed herein, in one or more of its various example embodiments and modes, comprises UE-initiated, UE autonomous and network-initiated methods. In the network-initiated case. The network-initiated case is illustrated by way of non-limiting example with reference to FIG. 3A and FIG. 3B. In the network-initiated case, the UE reports the AI/ML-associated internal issues/overheating information to the network. Based on received information, the network takes the decision on AI/ML model/functionality (re) configuration and indicates it to the UE. In other words, the network generates and transmits to the UE a network-proposed remedial action to address the wireless terminal performance condition.

An example implementation of a representative communication network 22 for the network-initiated cases/embodiments are shown in FIG. 3A; example acts or steps including message flows for the embodiment of FIG. 3A are illustrated in FIG. 4A.

In the example embodiments and modes of FIG. 3A and FIG. 4A, one or more nodes of the network may interact or communicate with the wireless terminal 20 which has the Artificial Intelligence/Machine Learning Model Capability. Such one or more nodes may be one or more nodes of core network 23, or one or more nodes of radio access network 24, or a combination of nodes comprising core network 23 and radio access network 24. For sake of simplicity, the one or more nodes of the network which communicate with the wireless terminal 20 are generically and/or collectively referred to as network node 34. Thus, network node 34 may, in potentially differing example embodiments and modes, be one or more nodes of core network 23, one or more nodes of radio access network 24, or may be distributed between one or more nodes of core network 23 and radio access network 24.

As mentioned above, FIG. 3A shows an example communication system 20 and in which wireless terminal 20 has artificial intelligence/machine learning model capability. As shown in FIG. 3A, the network node 34 comprises network node processor(s) 40. The network node processor(s) 40 may perform many functionalities for its resident node, as understood by those skilled in the art. For performing example functions germane to the example embodiment and mode of FIG. 3A, the network node processor(s) 40 may further comprise network artificial intelligence/machine learning capabilities controller 41, e.g., network AI/ML capabilities controller 41. The AI/ML capabilities controller 41 in turn may comprise artificial intelligence/machine learning capabilities models and functions manger 42, e.g., AI/ML capabilities models and functions manger 42; message manager 43; Artificial Intelligence/Machine Learning (AI/ML) message generator 44; and terminals AI/ML configuration manager 46. The network node 34 may further comprise network node interface circuitry 47. The network node interface circuitry 47 in turn may comprise network node transmitter circuitry 48 and network node receiver circuitry 49.

FIG. 3A further shows that the wireless terminal 20 may comprise wireless terminal transceiver circuitry 50. The wireless terminal transceiver circuitry 50 may in turn comprise wireless terminal receiver circuitry 52 and wireless terminal transmitter circuitry 54. The transceiver circuitry 50 may include antenna (e) for wireless transmission. The wireless terminal transmitter circuitry 54 may include, e.g., amplifier(s), modulation circuitry and other conventional transmission equipment. The wireless terminal receiver circuitry 52 may comprise, e.g., amplifiers, demodulation circuitry, and other conventional receiver equipment.

FIG. 3A further shows wireless terminal 20 also comprising wireless terminal processor circuitry, e.g., one or more wireless terminal processor(s) 60, as well as one or more Artificial Intelligence/Machine Learning (AI/ML)-related sensor(s) or Artificial Intelligence/Machine Learning (AI/ML)-information monitors 61. The wireless terminal 20, e.g., wireless terminal processor(s) 60, may comprise frame/message generator/handler 62. As is understood by those skilled in the art, in some telecommunications system messages, signals, and/or data are communicated over a radio or air interface using one or more “resources”, e.g., “radio resource(s)”

The wireless terminal processor(s) 60 may perform many functionalities for its wireless terminal, as understood by those skilled in the art. For performing example functions germane to the example embodiment and mode of FIG. 3A, the wireless terminal processor(s) 60 may further comprise terminal performance monitor/controller 63. The terminal performance monitor/controller 63 may in turn comprise performance condition detector 64; AI/ML capabilities models and function manager 65; report message generator 66G; response message handler 66H; event descriptor memory/controller 67; and remedial action controller 68.

Wireless terminal 20 may also comprise interfaces 69, including one or more user interfaces. Such user interfaces may serve for both user input and output operations and may comprise (for example) a screen such as a touch screen that can both display information to the user and receive information entered by the user. User interface 69 may also include other types of devices, such as a speaker, a microphone, or a haptic feedback device, for example.

Example acts or steps including message flows for the embodiment of FIG. 3A are illustrated in FIG. 4A. For example, FIG. 4A depicts a flow chart describing the UE 20 and the network behavior, when the UE experiences any changes in its wireless terminal performance condition, including additional conditions and UE's internal conditions, such as:
A UE internal issue, such as irregularities in one or more of device computation resource usage, power-consumption, RF and Power/resource consumption status, memory, battery status, storage, and other hardware limitations, etc.
Overheating due to AI/ML model or functionality configuration or operation, etc.
UE internal conditions and UE additional conditions which may comprise one or more of the following:
   Occurrence of certain scenarios, e.g., a certain channel model, a certain UE distribution, certain UE mobility levels, utilization of certain carrier frequencies, etc.
   Certain configurations, e.g., certain UE/gNB config, utilization of certain bandwidths, certain antenna port layouts.
      Utilization of Certain sites (e.g., Urban Macro, Indoor hotspot, Rural Macro, Urban Micro, cell sites).
      UE's internal conditions such as device computation usage, power-consumption, RF and Power/resource consumption status, memory, battery status, storage, and other hardware limitations etc.

As explained herein, network 22 may comprise of one or multiple entities for, e.g., RAN or CN, entities such as base station, LMF or similar entities. The UE may interact with one or more of such entities depending on the use-case, scenario, and conditions.

In act 1 of FIG. 4A, the network configures the UE to report internal issues or conditions, e.g., wireless terminal performance condition(s), e.g., overheating due, to active AI/ML model or configurations. Act 1 of FIG. 4A thus comprises an entity such as AI/ML capabilities controller 41 prompting generation and transmission of a configuration message to wireless terminal 20 to configure the wireless terminal 20 for reporting of events pertaining to one or more wireless terminal performance condition(s). The message of action 1 is received by transceiver circuitry 50 of wireless terminal 20. The events specified in the message of action 1 or otherwise configured at the wireless terminal 20 are stored in event descriptor memory/controller 67 of wireless terminal processor(s) 60. The triggering conditions to report may include certain pre-configured thresholds to trigger such computation resource usage, UE internal temperature, power consumption, etc., to detect internal issues/overheating. The configuration of the timer duration to the UE to detect internal issues and overheating may also be configured by the network in act 1 of FIG. 4A.

The triggering conditions to report UE's internal issues or problems e.g., overheating due to AI/ML operations/functions/models may be configured by the network or by the UE or by the UE vendor. UE's internal issues could be configured to report in an event-based or periodic manner. The network may also configure UE to periodically report or indicate ‘no issues or no overheating’.

As described herein, overheating due to AI/ML operations/functions/models is considered as an example of UE's internal issues that may occur in a UE supporting an AI/ML enabled feature. Other UE's internal issues are not excluded and are listed herein.

Once the UE is configured the UE may detects any internal issues/overheating due to AI/ML configuration (in act 2 of FIG. 4A). Detection of such internal issues may be facilitated by AI sensor 61 and communicated to a unit such as performance condition detector 64 which comprises wireless terminal processor(s) 60. Upon such detection, the UE initiates the reporting procedure by setting the content of the reporting message. As shown in act 3 of FIG. 4A, in this case a new or enhanced AI/ML overheat/internal issue UEAssistanceInformation or similar message maybe used to report overheat or other UE internal issues to the network. Generation and transmission of the reporting message may be implemented using report message generator 66G. In one option, the existing overheating UAI message may also be enhanced to include UE's AI/ML related configuration or model preferences. Such internal issues within the UE may also trigger reporting of additional conditions or any changes in applicability conditions.

The existing overheating UAI message indicates overheating in the modem e.g., algorithms running on the modem, due to the configuration related to the for e.g., MIMO layers, component carriers, aggregated bandwidth, etc. However, the technology disclosed herein encompasses scenarios where, the UE internal issues such as overheating due to AI/ML functions/model(s). The AI/ML functionality/model(s) may be running:
On same hardware (e.g., modem) or
A dedicated hardware (e.g., a CPU/GPU) within the device.

Thus, the internal issue such as overheating reporting due to AI/ML functions maybe done either independently or in correlation to modem configuration and AI/ML functions on dedicated hardware. It may also be jointly reported if the AI/ML functions and modem algorithms share the same processing unit/hardware.

As mentioned above, the UE internal issue reporting message may be an existing enhanced message or a new message respectively.

If transmission of the new or enhanced UEAssistanceInformation message is initiated to provide overheating assistance information the UE may for e.g., include the following information within the reporting message.
Preferences to switch model/(de) activate functionalities or AI/ML model(s), preferred AI/ML configuration for a given functionality etc. may be provided to the network by the UE based on monitoring of the AI/ML functionality/model.
The UE may also report the cause of overheat for e.g., due to AI/ML feature/functionality configuration or due to any AI/ML model currently active or had been active in the past.
Another example may include overheating due to more than one active feature/functionality or model(s) or computational complexity or power consumption, computational resource usage, UE internal temperature etc.
Preferences to switch off certain functions e.g., real-time functions, monitoring/data collection/training etc. if active may be sent to the network.
Use case specific information or changes in configuration for, e.g., for the CSI compression/estimation use case it could be CSI configuration or model monitoring and performance KPIs, for beam management use case it could be L1/L2/L3 beam configuration information or model monitoring and performance KPIs, similar configuration and KPIs for other use cases like positioning enhancement.

In one example implementation of the example embodiment and mode of FIG. 3A and FIG. 4A, the modification of existing overheating UAI may be done jointly/together/correlation with the new or enhanced AI/ML overheat/internal issue reporting message, an UAI-like message, for a target use-case or an AI/ML feature. Use case could be for, e.g., CSI estimation, Beam Management, Positioning etc.

As an example of the above, if the UE detects overheat due to UE's AI/ML model/functionality it may also trigger the existing overheat UAI message and request modifications in the configuration that may be affecting an AI/ML enabled feature for a given use-case. For example, the UE may identify the parameters related to the affected AI/ML functionality/model and request modifications indicating its preferred configuration changes to the network. Based on the AI/ML linked identified parameters the UE for, e.g., may request the following:
Reduce the number of maximum secondary component carriers.
Reduce maximum aggregated bandwidth in in FR (1, 2, 3 . . . x).
Reduce MIMO layers in UL/DL in FR (1, 2, 3 . . . x) etc.

Vice-versa, if the UE detects internal overheating (without AI/ML, i.e., conventional case where overheating condition has been detected by the UE) it may also trigger reconfiguration request for AI/ML feature/functionality or model via proposed reporting procedure.

Once the UE has set the contents of the new reporting message, it may trigger starting a new timer as shown in act 4 of FIG. 4A. In act 4 of FIG. 4A, the reporting message could be a new message or an enhanced existing message for, e.g., a modified UAI message, or an RRC reconfiguration message, etc.

Following act 4 of FIG. 4A, the UE transmits the new reporting message to the network as shown in act 5 of FIG. 4A. The transmission may occur through transmitter circuitry 54. The UE may also request a new configuration or indicate preferred AI/ML configuration/action/model etc. and may optionally report the cause for request for e.g., UE internal issues, overheating etc.

As shown in act 6 and act 7 of FIG. 4A, the information reported, including information such as additional and applicability conditions, by the UE to the network may also be indicated to the model training and storage entity for AI/ML model optimization purposes. The model training and storage entity for AI/ML may also be referred to herein as AI/ML capabilities controller 41. This may be indicated either via the network or directly depending on the location of the model storage and training entity.

In one example implementation of the embodiment and mode of FIG. 3A and FIG. 4A, the network may also request the UE side information for model training, model inference, model monitoring, model selection, model update, etc.

Upon receiving the message of act 5, the network 22 reviews the content of the message and indicates UE preferences and responds accordingly, including as described below.

As shown in act 8 of FIG. 4A, the network, may perform at least one of the following options for e.g., (re) configure or disable a functionality/feature associated with a use-case or the network may implicitly (by functionality re-configuration) or explicitly (de) activate a model. Switch model or trigger model update or (new message) request model (re) optimization or indicate fall back to the UE. The network may also modify parameters that are included in the existing UAI overheat message such as aggregated bandwidth, MIMO layers in UL/DL, component carrier etc. considering different frequencies. This may be done jointly with AI/ML model/functionality (re) configuration or individually. In an example embodiment and mode such actions may be undertaken by AI/ML capabilities controller 41. The network may also perform no action and/or let the timer expire such that UE may fall back to legacy procedure or act as per its pre-configuration.

In another example implementation of the example embodiment and mode of FIG. 3A and FIG. 4A, the UE or the network may predict or detect the overheating based on model behavior, past model behavior and past model/functionality configurations, past and present additional or applicable conditions, etc. The UE or the network may then send predictive overheat message to the network or to the UE respectively. This may help network or the UE to take corrective action (e., g., as described in act 8 of FIG. 4A.

Once the network has processed UE's message and made its decision, the network may indicate its decision or configuration via a reconfiguration message in act 9 of FIG. 4A. The reconfiguration message of act 9 may also be referred to herein as a response message over the radio interface from the radio network. The response may comprise an instruction for the wireless terminal to perform a remedial action as proposed by the network.

Upon receiving the response or reconfiguration message of act 9 from the network, the UE applies the network configuration, e.g., implements the network-proposed remedial action, and stops the timer as shown in FIG. 4A by act 10 and act 11, respectively. In an example embodiment and mode, application of the remedial action may be accomplished by remedial action controller 68. In another example, upon transmitting the report Config. Successful message, the UE may stop the timer.

A reconfiguration successful/failure message or command may optionally be sent to the network.

If for some reason the UE is not able to resolve its internal issues/overheating using, e.g., the network-proposed remedial action, and the timer expires, the UE may fall back to the legacy mechanisms and report it to the network with or without cause.

In another option, the gNB may pre-configure the UE for, e.g., to fall back to legacy mechanisms or switch to a default configuration and/or default AI/ML model provided by the gNB for a functionality/feature associated with a target use case.

In act 6 of FIG. 4A, the UE internal issues or overheating indication and cause maybe reported to the Model training and storage entity, e.g., AI/ML capabilities controller 41, which could be located inside or outside the 3GPP network, either via network or using non-3GPP technology. The model training and storage entity may then optimize/re-train the model based on for e.g., new additional/applicability conditions.

### Second Example Embodiment: Terminated-Initiated Cases

The terminal-initiated case is illustrated by way of non-limiting example with reference to FIG. 4A and FIG. 4B. In the term-initiated case. In the UE-initiated case, the UE determines and attempts to implement a UE-proposed solution to an internal issue, e.g., a terminal-proposed remedial action. That is, the UE undertakes the decision for AI/ML model/functionality (re) configuration (or the UE requests the network for AI/ML functionality reconfiguration with/without preferred configuration parameters), model selection/switching/(de) activation or fallback related decisions and report it to the network. The network may then accept or reject or propose an alternative action to the UE.

In UE autonomous mode, which is a variation or subset of the UE-initiated case, the UE takes the decision and may or may not report it to the network. Thus, the UE autonomous mode is a sub-mode of UE initiated mode. The primary difference between the UE initiated mode and UE-autonomous mode is that in UE autonomous mode, the UE performs its internal optimizations to rectify any internal issues, or the UE may internally take decisions (e.g., based on network pre-configuration) related to AI/ML model/functionality (re) configuration (or the UE requests for AI/ML functionality reconfiguration from the network with preferred configuration parameters), model selection/switching/(de) activation or fallback etc. but it is not obliged/expected to report it to the network. The UE autonomous mode may also be (pre) configured by the network to use specific AI/ML functionality configurations/models/model selection/switching/(de) activation or fallback conditions (including additional, applicability and UE internal conditions), etc.

An example implementation of a representative communication network 22 for the UE-initiated cases/embodiments are shown in FIG. 3B; example acts or steps including message flows for the embodiment of FIG. 3B are illustrated in FIG. 4B. Unless otherwise specified or clear from the context, units and functionalities of the communication system 18 of FIG. 3B have the same as those of FIG. 3A have the same or similar structure and operation as above described with reference to FIG. 3A. For example, communications network 22 may comprise one or more nodes of core network 23, or one or more nodes of radio access network 24, or a combination of nodes comprising core network 23 and radio access network 24. As in the first embodiment, in the FIG. 3B and FIG. 4B embodiment the one or more nodes of the network which communicate with the wireless terminal 20 are generically and/or collectively referred to as network node 34. Moreover, the network node 34 comprises network node processor(s) 40 which may comprise network artificial intelligence/machine learning capabilities controller 41, e.g., network AI/ML capabilities controller 41. The AI/ML capabilities controller 41 in turn may comprise artificial intelligence/machine learning capabilities models and functions manger 42, e.g., AI/ML capabilities models and functions manger 42; message manager 43; Artificial Intelligence/Machine Learning (AI/ML) message generator 44; and terminals AI/ML configuration manager 46. The network node 34 may further comprise network node interface circuitry 47. The network node interface circuitry 47 in turn may comprise network node transmitter circuitry 48 and network node receiver circuitry 49.

FIG. 3B further shows that the wireless terminal 20 may comprise wireless terminal transceiver circuitry 50. The wireless terminal transceiver circuitry 50 may in turn comprise wireless terminal receiver circuitry 52 and wireless terminal transmitter circuitry 54. The transceiver circuitry 50 may include antenna (e) for wireless transmission. The wireless terminal transmitter circuitry 54 may include, e.g., amplifier(s), modulation circuitry and other conventional transmission equipment. The wireless terminal receiver circuitry 52 may comprise, e.g., amplifiers, demodulation circuitry, and other conventional receiver equipment.

FIG. 3B further shows wireless terminal 20 also comprising wireless terminal processor circuitry, e.g., one or more wireless terminal processor(s) 60, as well as one or more Artificial Intelligence/Machine Learning (AI/ML)-related sensor(s) or Artificial Intelligence/Machine Learning (AI/ML)-information monitors 61. The wireless terminal 20, e.g., wireless terminal processor(s) 60, may comprise frame/message generator/handler 62. As is understood by those skilled in the art, in some telecommunications system messages, signals, and/or data are communicated over a radio or air interface using one or more “resources”, e.g., “radio resource(s)”.

The wireless terminal processor(s) 60 may perform many functionalities for its wireless terminal, as understood by those skilled in the art. For performing example functions germane to the example embodiment and mode of FIG. 3B, the wireless terminal processor(s) 60 may further comprise terminal performance monitor/controller 63. The terminal performance monitor/controller 63 may in turn comprise UE remedial action determination logic 56; performance condition detector 64; AI/ML capabilities models and function manager 65; report message generator 66G; response message handler 66H; event descriptor memory/controller 67; and remedial action controller 68.

Wireless terminal 20 may also comprise interfaces 69, including one or more user interfaces. Such user interfaces may serve for both user input and output operations and may comprise (for example) a screen such as a touch screen that can both display information to the user and receive information entered by the user. User interface 69 may also include other types of devices, such as a speaker, a microphone, or a haptic feedback device, for example.

Example acts or steps including message flows for the embodiment of FIG. 3B are illustrated in FIG. 4B. FIG. 3B shows the communications system 18 as comprising wireless terminal 20, a communications system including a network node such as network node 34, and a network and AI/ML storage and training entity. The network and AI/ML storage and training entity may comprise or be realized, at least in part, by AI/ML capabilities controller 41. The flowchart of FIG. 4B describes UE-initiated AI/ML management.

Act 1, act 2, and act 3 of FIG. 4B are similar to respectively numbered act described with reference to FIG. 4A respectively. Different from the solution depicted in FIG. 4A, in the example embodiment and mode of FIG. 4B upon detecting any internal issues like overheating, for example, the UE starts the timer, and first tries to internally resolve the issue by performing actions (shown in act 4 of FIG. 4B). For example, in the example implementation of FIG. 3B the wireless terminal 20 may employ UE remedial action determination logic 56 to develop or generate a UE-proposed remedial action to address the UE internal issue that is influenced or affected by Artificial Intelligence/Machine Learning (AI/ML). Such non-limiting, non-exhaustive examples of UE-proposed remedial action include the following strategies:
(1) The UE identifies whether the issue is in the modem or dedicated AI/ML processing unit or a shared AI/ML processing unit. The AI/ML processing unit may be shared with other computational/processing units such as modem, CPU etc.
(2) Reducing clock/performance, shutting down functions, features (software) etc.
(3) Adjusting the frequency and voltage of the hardware components based on the workload. During periods of lower demand, it reduces power consumption and heat generation. Many modern processors have built-in features for dynamic frequency scaling.
(4) Implementing effective power management techniques can help regulate the power consumption of the hardware. This might include dynamically adjusting power supply voltages, shutting down idle components, or intelligently managing power states.
(5) Monitoring and Control Systems:
   a. Implementing real-time monitoring of system temperature and workload can enable dynamic adjustments. If temperatures rise above a certain threshold, the system can respond by reducing the computational load, slowing down clock speeds, or activating additional cooling mechanisms.
(6) Parallelization and Distributed Computing:
   a. Distributing computations across multiple processors or nodes can help distribute the workload, reducing the burden on individual components and mitigating localized overheating.
(7) Optimal Workload Scheduling:
   a. Efficient workload scheduling ensures that tasks are distributed evenly across the available resources, preventing specific components from being overloaded.
(8) Triggering Firmware and Software Updates:
   a. Regularly updating firmware and software can provide access to optimizations and improvements that can enhance the efficiency of hardware components and reduce heat generation.
(9) A combination of one or more of the foregoing strategies

Act 4 may also be performed by the UE for the procedure discussed in FIG. 3A.

In one example implementation, the UE may also request network side additional conditions.

If the UE's proposed remedial action is successful without causing delays in pre and post processing of the data and without causing any inference latencies, the UE may stop the timer.

On the other hand, if the measures taken by the UE are not successful, the UE may itself autonomously perform AI/ML model (de) activation, mode update or switching or fallback or functionality reconfiguration etc. as shown in act 9 of FIG. 3A and then (optionally) report it to the network. Different from model update, the UE may initiate a new request with model re-optimization and may switch to a different model or fall back (also temporary fall back if required).

In one example implementation of the FIG. 3B and FIG. 4B embodiment, the UE may be (pre) configured by the network to use specific AI/ML functionality configurations/models/model selection/switching/(de) activation or fallback conditions (including additional, applicability and UE internal conditions) etc. this may be pre-configured based on what type of internal issues the UE experiences (e.g., overheating due to AI/ML operations).

As shown in act 10 of FIG. 4B, the UE may set the content of the AI/ML overheat/internal issue reporting message in similar way as described in act 3 of FIG. 4A. Following this, the UE may report the new reporting message to the network as shown in act 11 of FIG. 4B. In act 11, the UE may also inform the network about its actions performed in act 4, e.g., any internal optimizations performed, or any UE actions regarding re-configuration, model selection/update, switch, fall back etc. together with UE's internal conditions and additional conditions in act 9 respectively.

Upon receiving the UE's decision and response to internal issue, the network may perform the actions such as but not limited to
Accept or reject UE response which may lead to RRC failure if it is done using RRC.
No action.
Provide a network preferred AI/ML model/functionality configuration to the UE.
Trigger fallback.

The network's response may be indicated to the UE via a reconfiguration message as shown in step 13. The UE then applies the network configuration if provided as shown in step 14.

### Further Considerations

The message exchange between the network and the UE may be implemented using for e.g., messages like a UAI, User Assistance Information, an RRC message, or a layer 1/layer 2/layer 3, L1/L2/L3 message, or a new message or a higher layer message.

The UE may initiate the procedure in a pro-active or predictive manner however, in this case the UE may indicate to the network that this is pro-active or predictive as a measure to avoid a targeted UE internal issue that may occur in the future.

The act described in FIG. 3B and FIG. 4B may be performed in different orders or in different combinations. The AI/ML model may be within the 3GPP network or outside of the network.

Distinctions between the UE-assisted and UE autonomous modes are now further explained. Note 3: Clarification on UE assisted and UE autonomous modes. In the UE initiated case, the UE takes the decision for AI/ML model/functionality (re) configuration (or the UE requests the network for AI/ML functionality reconfiguration with/without preferred configuration parameters), model selection/switching/(de) activation or fallback related decisions and report it to the network. The network may then accept or reject or propose an alternative action to the UE. On the other hand, in the UE autonomous mode, the UE takes the decision and may or may not report it to the network.

The UE autonomous mode is thus a sub-mode of UE initiated mode. The primary difference between the UE initiated mode and UE-autonomous mode is that in UE autonomous mode, the UE performs its internal optimizations to rectify any internal issues, or the UE may internally take decisions (e.g., based on network pre-configuration) related to AI/ML model/functionality (re) configuration (or the UE requests for AI/ML functionality reconfiguration from the network with preferred configuration parameters), model selection/switching/(de) activation or fallback etc. but it is not obliged/expected to report it to the network. The UE autonomous mode may also be (pre) configured by the network to use specific AI/ML functionality configurations/models/model selection/switching/(de) activation or fallback conditions (including additional, applicability and UE internal conditions), etc.

It was mentioned above that the report message may be an extended UAI message. For example, the UAI may be extended to include information as:
Internal issue detection e.g., OverheatingAssistance AI/ML-rxx
Identify internal issue e.g., Overheat detection indication.
Overheat cause or cause of UE internal issue.
Rectification measures: e.g., internal optimizations and/or Model preference/selected options (e.g., using model ID)/switching/update/re-optimize request.
Functionality re-configuration request
Fall back initiation (including temporary fallback)
Preferred functionality configuration
Preferred model
Preferred action: e.g., fallback
UE side conditions
Indication if it's a predictive or a proactive action.
UE internal conditions reporting
Additional conditions reporting

Table 1 shows example contents of an example, non-limiting, and non-exhaustive implementation of a reporting message which describes structure for AI/ML related UE internal issue reporting message. The implementation of the reporting message of Table 1 may be converted to ASN.1 code.

### Table 1

User Assistance Information UserAssistanceInfo AI/ML internal issues (e.g., AI/ML overheating)::=SEQUENCE {
AI/ML UE internal issue AI/MLinternal issue
Assistance
Identification of internal issue AI/MLOverheatingAssistance cause AI/MLUEAssistance Information-cause
}
Overheat detection indication.
Overheat cause.
SEQUENCE {
   AI/ML model switch AI/ML model LCM,
   AI/ML model update AI/ML model LCM,
   AI/ML model re-optimization request AI/ML model LCM,
   Functionality re-configuration request AI/ML model LCM,
   Fall back initiation (including temporary fallback) AI/ML model LCM
   Preferred functionality configuration
   Preferred AI/ML model
   Preferred action: e.g., fallback
} OPTIONAL
SEQUENCE {
   UE internal conditions reporting Reporting
UE side conditions,
   Additional conditions reporting Reporting
UE side conditions
   } OPTIONAL,
}
END

Table 2 shows example contents of existing message, known as an UEAssistanceInformation message, which may be modified to serve as the reporting message. The UEAssistanceInformation message is used for the indication of UE assistance information to the network. In the description below, Signalling radio bearer: SRB1, SRB3; RLC-SAP: AM; Logical channel: DCCH; and Direction: UE to Network. Modifications to the existing message which are included to realize the reporting message of the technology disclosed herein are shown in bold face font. Table 2 is a copy-and-paste of the existing 3GPP specification (TS38.331) message and serves as just an example of how the technology disclosed herein can be implemented/realized by enhancing the existing message. The terminal disclaimer is not limited to the particular message shown in Table 1.

### Table 2

### UEAssistanceInformation Message

ASNISTART
TAG-UEASSISTANCEINFORMATION-START
UEAssistanceInformation::=SEQUENCE {
   criticalExtensions CHOICE {
      ueAssistanceInformation UEAssistanceInformation-IEs,
      criticalExtensionsFuture SEQUENCE { }
   }
}
UEAssistanceInformation-IEs::=SEQUENCE {
   delayBudgetReport DelayBudgetReport OPTIONAL,
   lateNonCriticalExtension OCTET STRING OPTIONAL,
   nonCriticalExtension UEAssistanceInformation-v1540-IEs OPTIONAL
}
DelayBudgetReport::=CHOICE {
   type1 ENUMERATED {
      msMinus1280, msMinus640, msMinus320,
      msMinus160, msMinus80, msMinus60, msMinus40,
      msMinus20, ms0, ms20,ms40, ms60, ms80, ms160, ms320, ms640, ms1280},
   . . .
}
UEAssistanceInformation-v1540-IEs::=SEQUENCE {
   overheatingAssistance OverheatingAssistance OPTIONAL,
   nonCriticalExtension UEAssistanceInformation-v1610-IEs OPTIONAL
}
OverheatingAssistance::=SEQUENCE {
   reducedMaxCCs ReducedMaxCCs-r16 OPTIONAL,
   reducedMaxBW-FR1 ReducedMaxBW-FRx-r16 OPTIONAL,
   reducedMaxBW-FR2 ReducedMaxBW-FRx-r16 OPTIONAL,
   reducedMaxMIMO-LayersFR1 SEQUENCE {
      reducedMIMO-LayersFR1-DL MIMO-LayersDL,
      reducedMIMO-LayersFR1-UL MIMO-LayersUL
   } OPTIONAL,
   reducedMaxMIMO-LayersFR2 SEQUENCE {
      reducedMIMO-LayersFR2-DL MIMO-LayersDL,
      reducedMIMO-LayersFR2-UL MIMO-LayersUL
   } OPTIONAL
}
OverheatingAssistance-r17::=SEQUENCE {
   reducedMaxBW-FR2-2-r17 SEQUENCE {
      reducedBW-FR2-2-DL-r17 ReducedAggregatedBandwidth-r17,
      reducedBW-FR2-2-UL-r17 ReducedAggregatedBandwidth-r17
   } OPTIONAL,
   reducedMaxMIMO-LayersFR2-2 SEQUENCE {
      reducedMIMO-LayersFR2-2-DL MIMO-LayersDL,
      reducedMIMO-LayersFR2-2-UL MIMO-LayersUL
   } OPTIONAL
}
ReducedAggregatedBandwidth::=ENUMERATED {mhz0, mhz10, mhz20, mhz30, mhz40, mhz50, mhz60, mhz80, mhz100, mhz200, mhz300, mhz400}
ReducedAggregatedBandwidth-r17::=ENUMERATED {mhz0, mhz100, mhz200, mhz400, mhz800, mhz1200, mhz1600, mhz2000}
UEAssistanceInformation-v1610-IEs::=SEQUENCE {
   idc-Assistance-r16 IDC-Assistance-r16 OPTIONAL,
   drx-Preference-r16 DRX-Preference-r16 OPTIONAL,
   MaxBW-Preference-r16 MaxBW-Preference-r16 OPTIONAL,
   maxCC-Preference-r16 maxMIMO-LayerPreference-r16
   MaxCC-Preference-r16 OPTIONAL,
   MaxMIMO-LayerPreference-r16 OPTIONAL,
   minSchedulingOffsetPreference-r16 MinSchedulingOffsetPreference-r16 OPTIONAL,
   releasePreference-r16 ReleasePreference-r16 OPTIONAL,
   sl-UE-AssistanceInformationNR-r16 SL-UE-AssistanceInformationNR-r16 OPTIONAL,
   reference TimeInfoPreference-r16 BOOLEAN OPTIONAL,
   nonCriticalExtension UEAssistanceInformation-v1700-IEs OPTIONAL
}
UEAssistanceInformation-v1700-IEs::=SEQUENCE {
   ul-GapFR2-Preference-r17 UL-GapFR2-Preference-r17 OPTIONAL,
   musim-Assistance-r17 MUSIM-Assistance-r17 OPTIONAL,
   overheatingAssistance-r17 OverheatingAssistance-r17 OPTIONAL,
   maxBW-PreferenceFR2-2-r17 MaxBW-PreferenceFR2-2-r17 OPTIONAL,
   maxMIMO-LayerPreferenceFR2-2-r17 MaxMIMO-LayerPreferenceFR2-2-r17
OPTIONAL,
   minSchedulingOffsetPreferenceExt-r17 MinSchedulingOffsetPreferenceExt-r17
OPTIONAL,
   rlm-MeasRelaxationState-r17 BOOLEAN OPTIONAL,
   bfd-MeasRelaxationState-r17 BIT STRING (SIZE (1 . . . maxNrofServingCells))
OPTIONAL,
   nonSDT-DataIndication-r17 SEQUENCE {resumeCause-r17 ResumeCause OPTIONAL
   } OPTIONAL,
   scg-DeactivationPreference-r17 ENUMERATED {scgDeactivationPreferred,
   noPreference} OPTIONAL,
   uplinkData-r17 ENUMERATED {true} OPTIONAL,
   rrm-MeasRelaxationFulfilment-r17 BOOLEAN OPTIONAL,
   propagationDelayDifference-r17 PropagationDelayDifference-r17 OPTIONAL,
   nonCriticalExtension SEQUENCE { } OPTIONAL
}

The technology disclosed herein thus encompasses various embodiments and mode. A first example embodiment and mode involves or includes at least to some degree network based reporting of UE's AI/ML related internal issues. Considerations for the first example embodiment and mode may include one or more of the following:
A new message like UAI (user assistance information) which the UE may use to report its internal issues or overheating due to AI/ML model or functionality to the network.
The network may also configure triggering conditions to the UE for reporting internal issues such as overheating due to AI/ML operations. Such reporting could be event-based or periodic. The network may also configure UE to periodically report or indicate ‘no issues or no overheating’. This consideration is also applicable to the second consideration is also applicable to the second example embodiment and mode.
The UE may also report to the network when it is not experiencing, or it has stopped experiencing internal issues, which may be configurable by the network.
An enhanced existing L1/L2/L3 or higher layer message may also be used. For e.g., the existing UAI for reporting overheating may be enhanced to report internal issues or overheating due to active AI/ML model/functionality.
The modification of existing overheating UAI may be done jointly/together with the new or enhanced AI/ML overheat/internal issue reporting message (UAI like message) for a target use-case or an AI/ML feature.
Network may re-configure the UE e.g., functionality reconfiguration and/or model switch, update or issue a fallback command.
Predictive and proactive actions.
A timer-based approach is proposed to trigger reporting of UE internal issues to the network. UE behavior is defined on timer initiation, stopping and expiry.

A first example embodiment and mode involves or includes at least to some degree UE based reporting of UE's AI/ML related internal issues. Considerations for the second example embodiment and mode may include one or more of the following:
UE behavior and reporting mechanism when a UE detects internal issues such as overheating due to active AI/ML model or functionality in a feature for a given use case.
UE initiated:
   The UE takes the decision (without network pre-configuration) for AI/ML model/functionality (re) configuration (or the UE requests the network for AI/ML functionality reconfiguration with/without preferred configuration parameters), model selection/switching/(de) activation or fallback related decisions and report it to the network.
UE autonomous mode:
   UE performs its internal optimizations to rectify any internal issues, or the UE may internally take decisions (e.g., based on network pre-configuration) related to AI/ML model/functionality (re) configuration (or the UE requests for AI/ML functionality reconfiguration from the network with preferred configuration parameters), model selection/switching/(de) activation or fallback etc. but it is not obliged/expected to report it to the network.
   UE is (pre) configured by the network to use specific AI/ML functionality configurations/models/model selection/switching/(de) activation or fallback conditions (including additional, applicability and UE internal conditions) etc.
The UE internal issue/overheat timer and corresponding behavior.
Predictive and Proactive actions.
Messages proposed in invention 1 is used for reporting.

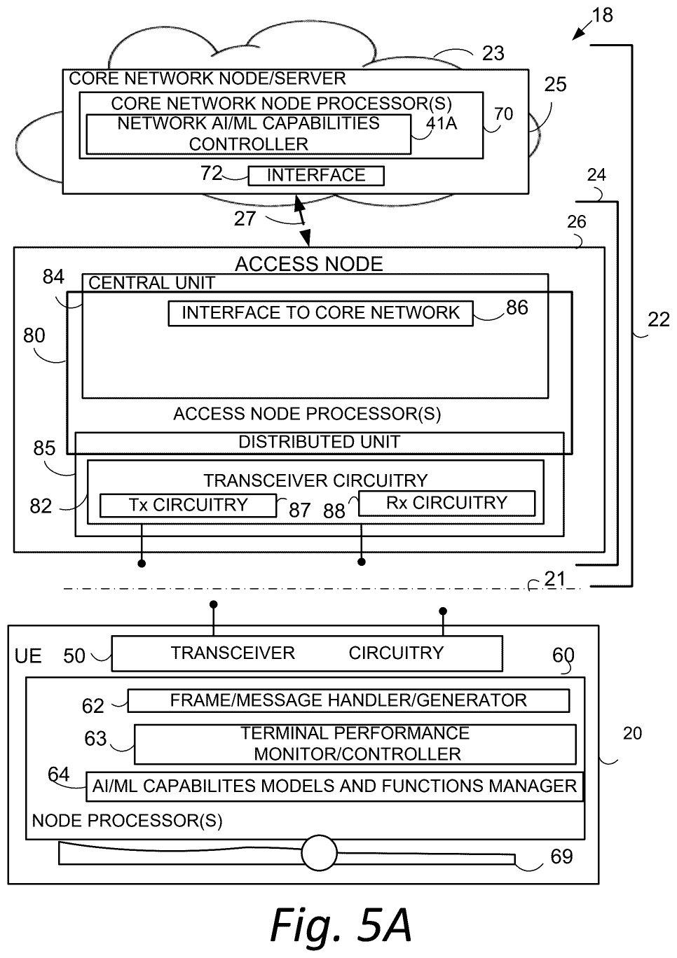

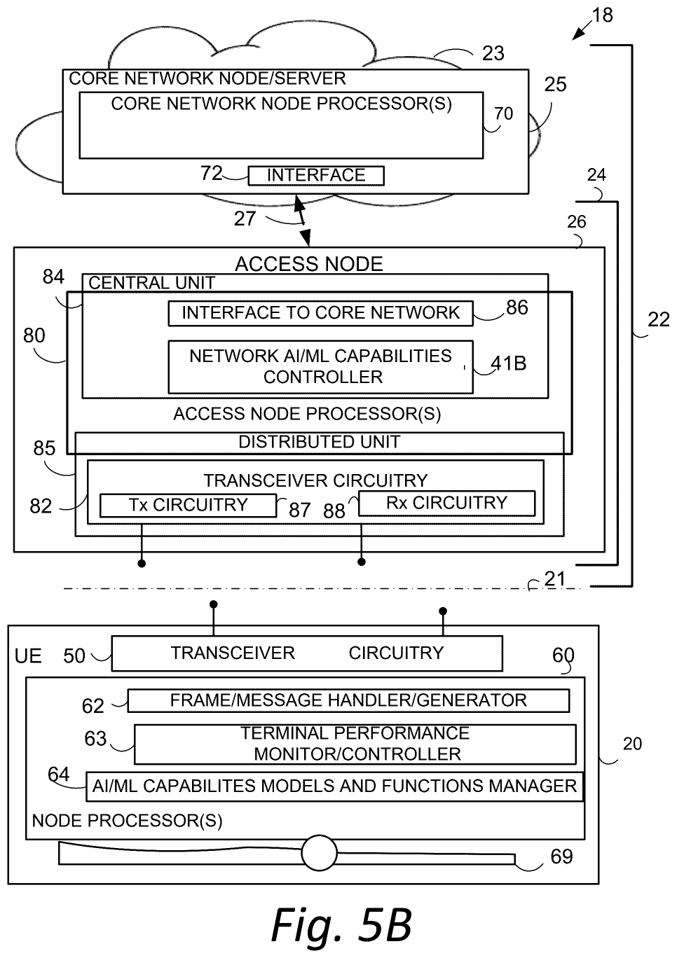

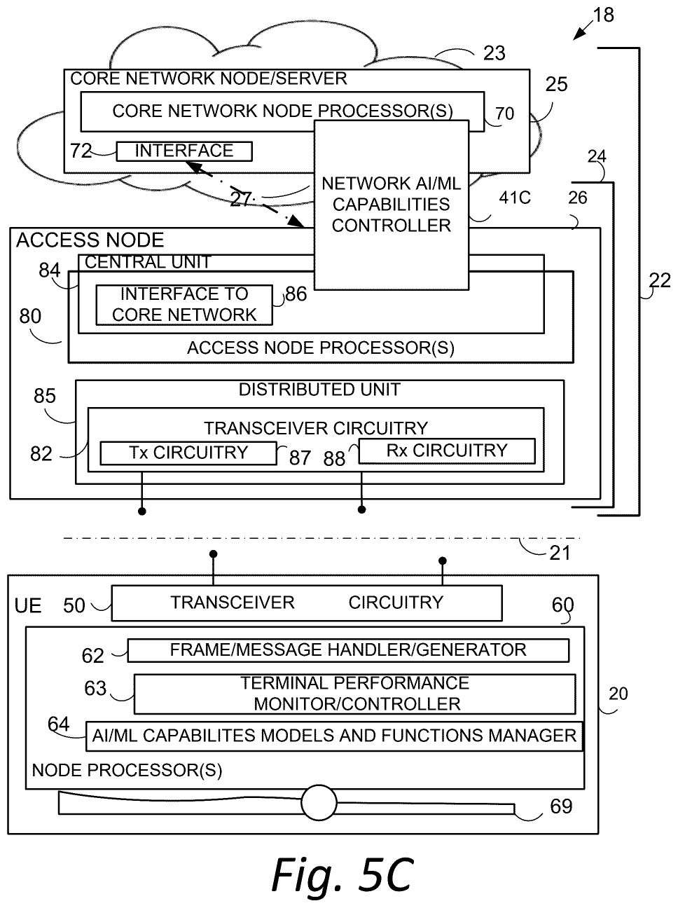

Network node 34 of FIG. 3A and/or FIG. 4A may, in potentially differing example embodiments and modes, be one or more nodes of core network 23 as illustrated by way of example in FIG. 5A; or one or more nodes of radio access network 24 as illustrated by way of example in FIG. 5B; or may be distributed between one or more nodes of core network 23 and radio access network 24 as illustrated by way of example in FIG. 5C.

FIG. 5A-FIG. 5C shows example embodiments and modes of communication network 22 in which core network 23 comprises core network node 25 and in which radio access network 24 comprises access node 26. The core network node 25 in turn comprises core network node processor(s) 70 and core network node interface(s) circuitry 72.

The access node 26 of FIG. 5A-FIG. 5C may comprise access node processor(s) 80 and access node transceiver circuitry 82. The access node 26 may comprise distributed architecture and may also comprise access node central unit 84 and access node distributed unit 85. The access node central unit 84 may comprise access node interface circuitry 86 to the core network 23. The access node distributed unit 85 may comprise access node transceiver circuitry 82. The access node transceiver circuitry 82 may include access node transmitter circuitry 87 and access node receiver circuitry 88.

In the example embodiment and mode of FIG. 5A the network node 34 comprises the core network node 25 since the AI/ML capabilities controller 41A resides in the core network node 25. By contrast, in the example embodiment and mode of FIG. 5B the network node 34 comprises the access node 26 since the AI/ML capabilities controller 41B resides in the access node 26 of FIG. 4. By further contrast, in the example embodiment and mode of FIG. 5C the network node 34 comprises both the core network node 25 and the access node 26 since the AI/ML capabilities controller 41C resides at least partially in both the core network node 25 and in the access node 26 of FIG. 5C, e.g., is distributed among one or more nodes of the core network 23 and radio access network 24.

FIG. 6 shows an example method of operation of a communication network and a wireless terminal involving a potential delay in reconfiguration of an already active Artificial Intelligence/Machine Learning (AI/ML) functionality. FIG. 6 shows general, non-limiting, example acts including act 6-1 through act 6-7.

The technology disclosed herein involves and/or concerns detection of wireless terminal performance condition influenced or affected by Artificial Intelligence/Machine Learning (AI/ML) implemented at a wireless terminal. In some of its example aspects the technology disclosed herein also seeks remediation of the wireless terminal performance condition, either as proposed by a communications network or by the wireless terminal. Other example aspects of the technology disclosed herein concern communications between the network and the wireless terminal involved in the detection and/or remediation, and communications associated therewith. As such, the technology disclosed herein concerns the structure and operation of networks, including network nodes, and wireless terminals that are involved in the determination or anticipation of influences and effects of Artificial Intelligence/Machine Learning (AI/ML). It will thus be appreciated that the technology disclosed herein is directed to solving radio communications-centric issues and is necessarily rooted in computer technology and overcomes problems specifically arising in radio communications. Moreover, the technology disclosed herein improves operation of wireless terminals with artificial intelligence/machine learning model capability.

Certain units and functionalities of the systems 18 may be implemented by electronic machinery. For example, electronic machinery may refer to the processor circuitry described herein, such as terminal processor circuitry 60, core network node processor(s) 70, and access node processor(s) 80. Moreover, the term “processor circuitry” is not limited to mean one processor, but may include plural processors, with the plural processors operating at one or more sites. Moreover, as used herein the term “server” is not confined to one server unit but may encompass plural servers and/or other electronic equipment and may be co-located at one site or distributed to different sites. With these understandings, FIG. 6 shows an example of electronic machinery, e.g., processor circuitry, as comprising one or more processors 90, program instruction memory 92; other memory 94 (e.g., RAM, cache, etc.); input/output interfaces 96 and 97, peripheral interfaces 98; support circuits 99; and busses 100 for communication between the aforementioned units. The processor(s) 90 may comprise the processor circuitries described herein, for example, wireless terminal processor(s) 60, core network node processor(s) 70, access node processor(s) 80, or any processor(s) of a network entity of the core network.

A memory or register described herein may be depicted by memory 94, or any computer-readable medium, may be one or more of readily available memory such as random access memory (RAM), read only memory (ROM), floppy disk, hard disk, flash memory or any other form of digital storage, local or remote, and is preferably of non-volatile nature, as and such may comprise memory. The support circuits 99 are coupled to the processors 90 for supporting the processor in a conventional manner. These circuits include cache, power supplies, clock circuits, input/output circuitry and subsystems, and the like.

The term “configured” may relate to the capacity of a device whether the device is in an operational or non-operational state. Configured may also refer to specific settings in a device that affect the operational characteristics of the device whether the device is in an operational or nonoperational state. In other words, the hardware, software, firmware, registers, memory values, and/or the like may be “configured” within a device, whether the device is in an operational or nonoperational state, to provide the device with specific characteristics.

An interface may be a hardware interface, a firmware Interface, a software interface, and/or a combination thereof. The hardware interface may include connectors, wires, electronic devices such as drivers, amplifiers, and/or the like. A software interface may include code stored in a memory device to implement protocol(s), protocol layers, communication drivers, device drivers, combinations thereof, and/or the like. A firmware interface may include a combination of embedded hardware and code stored in and/or in communication with a memory device to implement connections, electronic device operations, protocol(s), protocol layers, communication drivers, device drivers, hardware operations, combinations thereof, and/or the like.

Although the processes and methods of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture.

The functions of the various elements including functional blocks, including but not limited to those labeled or described as “computer”, “processor” or “controller”, may be provided using hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be embodied entirely within any form of computer-readable memory, such as solid-state memory, magnetic disk, or optical disk containing an appropriate set of computer instructions that would cause a processor to carry out the techniques described herein.

The technology of the example embodiments and modes described herein encompasses a non-transitory computer readable medium encoded with a computer program that, when executed by a computer or processor of the wireless terminal described herein, causes the computer to implement the acts described herein, and/or a non-transitory computer readable medium encoded with a computer program that, when executed by a computer or processor of the mobile base station relay described herein, causes the computer to implement the acts described herein.

Moreover, each functional block or various features of the wireless terminals and nodes employed in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

The technology disclosed herein encompasses but is not limited to the following example embodiments:

Example Embodiment 1: A wireless terminal which communicates over a radio interface with a radio network, the wireless terminal comprising:
processor circuitry configured to
   determine an event which pertains to a wireless terminal performance condition which is affected/influenced at least in part by an active Artificial Intelligence/Machine Learning (AI/ML) model or functionality of the wireless terminal;
   generate a report message which pertains to the event;
interface circuitry configured to transmit the report message over the radio interface to the radio network.

Example Embodiment 2: The wireless terminal of Example Embodiment 1, wherein the wireless terminal performance condition comprises overheating at the wireless terminal.

Example Embodiment 3: The wireless terminal of Example Embodiment 1, wherein the event pertains to remediation of a wireless terminal performance condition, and wherein the event comprises one of the following:
an occurrence or onset of the wireless terminal performance condition;
non-occurrence or cessation of the wireless terminal performance condition.

Example Embodiment 4: The wireless terminal of Example Embodiment 1, wherein the event pertains to checking of the wireless terminal performance condition, and wherein the event comprises at least one of the following:
a predetermined reporting time;
the wireless terminal performance condition reaching a report triggering threshold.

Example Embodiment 5: The wireless terminal of Example Embodiment 4, wherein the report triggering threshold is either:
received by the interface circuitry over the radio interface from the network;
configured at the wireless terminal.

Example Embodiment 6: The wireless terminal of Example Embodiment 1, wherein the event pertains to a prediction of the wireless terminal performance condition.

Example Embodiment 7: The wireless terminal of claim 6, wherein the processor circuitry is configured to make the prediction of the wireless terminal performance condition based on one or more of the following:
model behavior;
past model behavior;
past model/functionality configurations; and,
past and present additional or applicable conditions.

As used herein, additional conditions comprise, e.g., scenarios, sites, and datasets as determined/identified between UE-side and NW-side. “Applicability” and “Applicable conditions” are defined as below:
Applicability: whether at a given point in time a UE/NW-side AIML model/functionality is applicable/suitable to the e.g., scenarios/location/configuration/deployment/etc.
Applicable conditions: the specific characteristics under which a model/functionality can be setup, e.g., the specific scenarios/location/configuration/deployment/etc.

Applicability or additional conditions may include, for example, but are not limited to:
1) certain scenarios, e.g., channel model, UE distribution, UE mobility levels, carrier frequencies, etc.
2) certain configurations (e.g., UE/gNB config, bandwidths, antenna port layouts).
3) certain sites.

Example Embodiment 8: The wireless terminal of Example Embodiment 1, wherein the report message comprises one or more of the following:
a message which is dedicated to reporting one or more wireless terminal performance conditions;
a message which also includes information concerning a wireless terminal performance condition which is affected/influenced by an aspect of operation of the wireless terminal other than any active Artificial Intelligence/Machine Learning (AI/ML) model or functionality of the wireless terminal.

Example Embodiment 9: The wireless terminal of Example Embodiment 8, wherein the report message comprises a user assistance information message which is dedicated to reporting the one or more wireless terminal performance conditions.

Example Embodiment 10: The wireless terminal of Example Embodiment 1, wherein the interface circuitry is further configured to receive a response message over the radio interface from the radio network, and wherein the response comprises an instruction for the wireless terminal to perform a remedial action.

Example Embodiment 11: The wireless terminal of Example Embodiment 10, wherein the remedial action comprises one or more of:
a reconfiguration or switch of Artificial Intelligence/Machine Learning (AI/ML) model or functionality;
an update of Artificial Intelligence/Machine Learning (AI/ML) model or functionality;
a fall back procedure.

Example Embodiment 12: The wireless terminal of Example Embodiment 11, wherein the processor circuitry is further configured to implement the remedial action.

Example Embodiment 13: The wireless terminal of Example Embodiment 1, wherein the processor circuitry is further configured to perform a predetermined action if a response message is not received by the interface circuitry from the radio network within a predetermined time.

Example Embodiment 14: The wireless terminal of Example Embodiment 13, wherein the predetermined action comprises a fallback to a legacy procedure.

Example Embodiment 15: A network including one or more nodes which communicates over a radio interface with a wireless terminal, the network comprising:
interface circuitry configured to receive a report message over the radio interface, the report message comprising information pertaining to a wireless terminal performance condition which is affected/influenced at least in part by an active Artificial Intelligence/Machine Learning (AI/ML) model or functionality of the wireless terminal;
processor circuitry configured to generate a response message comprising an instruction for the wireless terminal to perform a remedial action; and
wherein the interface circuitry is further configured to transmit the response message to the wireless terminal over the radio access network.

Example Embodiment 16: The network of Example Embodiment 15,
wherein the processor circuitry is further configured to generate a report triggering message which comprises information concerning an event which invites reporting of the wireless terminal performance condition; and
wherein the interface circuitry is further configured to transmit the response message to the wireless terminal over the radio access network.

Example Embodiment 17: A method in a wireless terminal which communicates over a radio interface with a radio access network, the method comprising:
determining an event which pertains to a wireless terminal performance condition which is affected/influenced at least in part by an active Artificial Intelligence/Machine Learning (AI/ML) model or functionality;
generating a report message which includes an indication of the event;
transmitting the report message over the radio interface to the radio network.

Example Embodiment 18: A wireless terminal which communicates over a radio interface with a radio network, the wireless terminal comprising:
processor circuitry configured to
   determine an event which pertains to a wireless terminal performance condition which is affected/influenced at least in part by an active Artificial Intelligence/Machine Learning (AI/ML) model or functionality;
   implement a terminal-proposed remedial action configured to implement the wireless terminal performance condition;
   optionally generate a resolution report message which reports that implementation of the remedial action has resolved the wireless terminal performance condition;
interface circuitry configured to optionally transmit the report message over the radio interface to the radio network.

Example Embodiment 19: The wireless terminal of Example Embodiment 18, wherein the terminal-proposed remedial action comprises one or more of:
(1) Identifying whether the wireless terminal performance condition relates to a modem or dedicated AI/ML processing unit or a shared AI/ML processing unit;
(2) Reducing clock/performance of the wireless terminal;
(3) shutting down one or more functions or features of the wireless terminal;
(4) adjusting the frequency and voltage of the hardware components based on the workload of the wireless terminal;
(5) implementing an effective power management technique;
(6) implementing real-time monitoring of system temperature and/or workload;
(7) distributing computations across multiple processors or nodes;
(8) modifying workload scheduling;
(9) triggering firmware and/or software updates; and
(10) a combination of one or more of (1)-(10).

Example Embodiment 20: The wireless terminal of Example Embodiment 18, wherein:
the processor circuitry is configured to generate a problem report message if the wireless terminal performance condition is not resolved within a predetermined time by the implementation of the terminal-proposed remedial action; and
the interface circuitry is configured to transmit the problem report message over the radio interface to the radio network.

Example Embodiment 21: The wireless terminal of Example Embodiment 20, wherein:
the interface circuitry is further configured to receive a response message over the radio interface from the radio network, and wherein the response comprises an instruction for the wireless terminal to perform a network-prescribed remedial action.

Example Embodiment 22: The wireless terminal of Example Embodiment 21, wherein the processor circuitry is further configured to implement the network-prescribed remedial action.

Example Embodiment 23: The wireless terminal of Example Embodiment 21, wherein the processor circuitry is further configured to perform a predetermined action if the response message is not received by the interface circuitry from the radio network within a predetermined period.

Example Embodiment 24: The wireless terminal of Example Embodiment 23, wherein the predetermined action comprises a fallback to a legacy procedure.

Example Embodiment 25: The wireless terminal of Example Embodiment 18, wherein the remedial action comprises one or more of:
a reconfiguration or switch of Artificial Intelligence/Machine Learning (AI/ML) model or functionality;
an update of Artificial Intelligence/Machine Learning (AI/ML) model or functionality; and
implementation of a fall back procedure.

Example Embodiment 26: The wireless terminal of Example Embodiment 18, wherein the wireless terminal performance condition comprises at least one of the following:
A UE internal issue, such as irregularities in one or more of device computation resource usage, power-consumption, RF and Power/resource consumption status, memory, battery status, storage, and other hardware limitations, etc.
Overheating due to AI/ML model or functionality configuration or operation, etc.
UE internal conditions and UE additional conditions which may comprise one or more of the following:
   Occurrence of certain scenarios, e.g., a certain channel model, a certain UE distribution, certain UE mobility levels, utilization of certain carrier frequencies, etc.
   Certain configurations, e.g., certain UE/gNB config, utilization of certain bandwidths, certain antenna port layouts.
      Utilization of Certain sites (e.g., Urban Macro, Indoor hotspot, Rural Macro, Urban Micro, cell sites).
      UE's internal conditions such as device computation usage, power-consumption, RF and Power/resource consumption status, memory, battery status, storage, and other hardware limitations etc.

Example Embodiment 27: The wireless terminal of Example Embodiment 18, wherein the event comprises one of the following:
an occurrence or onset of the wireless terminal performance condition;
non-occurrence or cessation of the wireless terminal performance condition.

Example Embodiment 28: The wireless terminal of Example Embodiment 18, wherein the event comprises the wireless terminal performance condition reaching a report triggering threshold.

Example Embodiment 29: The wireless terminal of Example Embodiment 27, wherein the report triggering threshold is either:
received by the interface circuitry over the radio interface from the network; or
configured at the wireless terminal.

Example Embodiment 30: The wireless terminal of Example Embodiment 18, wherein the event comprises a prediction of the wireless terminal performance condition.

Example Embodiment 31: The wireless terminal of Example Embodiment 30, wherein the processor circuitry is configured to make the prediction of the wireless terminal performance condition based on one or more of the following:
model behavior;
past model behavior;
past model/functionality configurations; and,
past and present additional or applicable conditions.

Example Embodiment 32: The wireless terminal of Example Embodiment 20, wherein the problem report message comprises one of the following:
a message which is dedicated to reporting one or more wireless terminal performance conditions;
a message which also includes information concerning a wireless terminal performance condition which is affected/influenced by an aspect of operation of the wireless terminal other than any active Artificial Intelligence/Machine Learning (AI/ML) model or functionality of the wireless terminal.

Example Embodiment 33: The wireless terminal of Example Embodiment 32, wherein the problem report message comprises a user assistance information message which is dedicated to reporting the one or more wireless terminal performance conditions.

Example Embodiment 34: A method in a wireless terminal which communicates over a radio interface with a radio access network, the method comprising:
determining an event which pertains to remediation of a wireless terminal performance condition which is affected/influenced at least in part by an active Artificial Intelligence/Machine Learning (AI/ML) model or functionality;
implementing a terminal-proposed remedial action configured to implement the wireless terminal performance condition; and then
optionally generating a resolution report message which reports that implementation of the remedial action has resolved the wireless terminal performance condition;
optionally transmitting the report message over the radio interface to the radio network.

Example Embodiment 35: The method of Example Embodiment 34, further comprising:
generating a problem report message if the wireless terminal performance condition is not resolved within a predetermined time by the implementation of the terminal-proposed remedial action;
transmitting the problem report message over the radio interface to the radio network;
receiving a response message over the radio interface from the radio network, wherein the response comprises an instruction for the wireless terminal to perform a network-proposed remedial action;
implementing the network-proposed remedial action.

Example Embodiment 36: A network including one or more nodes which communicates over a radio interface with a wireless terminal, the network comprising:
interface circuitry configured to receive a problem report message over the radio interface from the wireless terminal, the problem report message comprising information indicating that a wireless terminal performance condition has not been resolved within a predetermined time by the implementation of a terminal-proposed remedial action;
processor circuitry configured to generate a response message comprising an instruction for the wireless terminal to perform a network-proposed remedial action; and
wherein the interface circuitry is further configured to transmit the response message to the wireless terminal over the radio access network.

One or more of the following documents may be pertinent to the technology disclosed herein (all of which are incorporated herein by reference in their entirety):
3GPP TSG RAN WG1, R1-230xxxx, #113, Incheon, Korea, May 22-May 26, 2023, Session notes for 9.2 (Study on AI/ML for NR air interface).
3GPP TSG-RAN WG2 Meeting #122R2-2xxxxxx, Incheon, Korea, May 22-26, 2023, Source: RAN2 Chairman (MediaTek), Title: Chair Notes
3GPP TSG-RAN WG1 Meeting #113, R1-2305327, Incheon, KR, May 22-May 26, 2023, Agenda item: 9.2.1, Source: Qualcomm Incorporated, Title: General Aspects of AI/ML Framework

Although the description above contains many specificities, these should not be construed as limiting the scope of the technology disclosed herein but as merely providing illustrations of some of the presently preferred embodiments of the technology disclosed herein. Thus, the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

What is claimed is:

1. A wireless terminal which communicates over a radio interface with a radio network,
the wireless terminal comprising:
processor circuitry configured to
determine an event which pertains to a wireless terminal performance condition which is affected/influenced at least in part by an active Artificial Intelligence/Machine Learning (AI/ML) model or functionality of the wireless terminal;
generate a report message which pertains to the event;
interface circuitry configured to transmit the report message over the radio interface to the radio network.

2. The wireless terminal of claim 1, wherein the wireless terminal performance condition comprises at least one of the following:
a UE internal issue, including one or more of irregularities in one or more of device computation resource usage, power-consumption, RF and Power/resource consumption status, memory, battery status, storage, and other hardware limitations,
overheating due to AI/ML model or functionality configuration or operation,
UE internal conditions and UE additional conditions which may comprise one or more of the following:
occurrence of certain scenarios including one or more of a certain channel model, a certain UE distribution, certain UE mobility levels, utilization of certain carrier frequencies,
certain configurations including one or more of a certain UE/gNB config, utilization of certain bandwidths, certain antenna port layouts,
utilization of certain sites,
UE's internal conditions such as device computation usage, power-consumption, RF and Power/resource consumption status, memory, battery status, storage, and other hardware limitations.

3. The wireless terminal of claim 1, wherein the event pertains to remediation of a wireless terminal performance condition.

4. The wireless terminal of claim 1, wherein the event pertains to checking of the wireless terminal performance condition.

5. The wireless terminal of claim 4, wherein the report triggering threshold is either:
received by the interface circuitry over the radio interface from the network;
configured at the wireless terminal.

6. The wireless terminal of claim 1, wherein the event pertains to a prediction of the wireless terminal performance condition.

7. The wireless terminal of claim 1, wherein the report message comprises one or more of the following:
a message which is dedicated to reporting one or more wireless terminal performance conditions;
a message which also includes information concerning a wireless terminal performance condition which is affected/influenced by an aspect of operation of the wireless terminal other than any active Artificial Intelligence/Machine Learning (AI/ML) model or functionality of the wireless terminal.

8. The wireless terminal of claim 7, wherein the report message comprises a user assistance information message which is dedicated to reporting the one or more wireless terminal performance conditions.

9. The wireless terminal of claim 1, wherein the interface circuitry is further configured to receive a response message over the radio interface from the radio network, and wherein the response comprises an instruction for the wireless terminal to perform a remedial action.

10. The wireless terminal of claim 9, wherein the remedial action comprises one or more of:
a reconfiguration or switch of Artificial Intelligence/Machine Learning (AI/ML) model or functionality;
an update of Artificial Intelligence/Machine Learning (AI/ML) model or functionality;
a fall back procedure.

11. The wireless terminal of claim 9, wherein the processor circuitry is further configured to implement the remedial action.

12. The wireless terminal of claim 1, wherein the processor circuitry is further configured to perform a predetermined action if a response message is not received by the interface circuitry from the radio network within a predetermined time.

13. A network including one or more nodes which communicates over a radio interface with a wireless terminal, the network comprising:
interface circuitry configured to receive a report message over the radio interface, the report message comprising information pertaining to a wireless terminal performance condition which is affected/influenced at least in part by an active Artificial Intelligence/Machine Learning (AI/ML) model or functionality of the wireless terminal;
processor circuitry configured to generate a response message comprising an instruction for the wireless terminal to perform a remedial action; and
wherein the interface circuitry is further configured to transmit the response message to the wireless terminal over the radio access network.

14. The network of claim 13,
wherein the processor circuitry is further configured to generate a report triggering message which comprises information concerning an event which invites reporting of the wireless terminal performance condition; and
wherein the interface circuitry is further configured to transmit the response message to the wireless terminal over the radio access network.

15. A method in a wireless terminal which communicates over a radio interface with a radio access network, the method comprising:
determining an event which pertains to a wireless terminal performance condition which is affected/influenced at least in part by an active Artificial Intelligence/Machine Learning (AI/ML) model or functionality;
generating a report message which includes an indication of the event;
transmitting the report message over the radio interface to the radio network.
